(19) United States
(12) Patent Application Publication
(10) Pub. No.: US 2026/0072419 A1
(43) Pub. Date: Mar. 12, 2026

(54) DATA PROCESSING APPARATUS, DATA PROCESSING METHOD, AND NON-TRANSITORY COMPUTER-READABLE STORAGE MEDIUM STORING DATA PROCESSING PROGRAM

(71) Applicant: SEIKO EPSON CORPORATION, Tokyo (JP)

(72) Inventor: Norihisa HAGIWARA, Suwa-shi (JP)

(21) Appl. No.: 19/325,641

(22) Filed: Sep. 11, 2025

(30) Foreign Application Priority Data
Sep. 12, 2024 (JP) 2024-157951

(51) Int. Cl. G05B 19/418

(52) U.S. Cl. CPC G05B 19/4183; G05B 19/41885

(57) ABSTRACT

A data processing apparatus includes an acquisition unit that acquires a data set, a structuring unit that generates structured data representing a causal structure between a conditional variable and an objective variable by connecting a leaf node representing the conditional variable, a root node representing the objective variable, and an intermediate node representing an element having an influence on the objective variable using the data set, and a modeling unit that models a manufacturing apparatus by sequentially calculating a function representing a variable of an upper node as an end point of the specific edge by using a variable of a lower node as a start point of the specific edge from the leaf node to the root node using the data set, and generating a model function as a function including the calculated explanatory function.

The present application is based on, and claims priority from JP Application Serial Number 2024-157951, filed Sep. 12, 2024, the disclosure of which is hereby incorporated by reference herein in its entirety.

### BACKGROUND

### 1. Technical Field

The present disclosure relates to techniques of a data processing apparatus, a data processing method, and a non-transitory computer-readable storage medium storing a data processing program.

### 2. Related Art

In related art, when the quality of a product manufactured by operating a molding machine changes due to an external factor or a slight difference in components contained in materials of a molding material, an apparatus that can modify an operating condition of the molding machine so as to bring the quality of the product close to a reference value is known (JP-A-2021-191620). The apparatus estimates the quality of the product using a learned model that outputs the quality of the product when a feature value extracted from detection data at manufacturing of the product using the molding machine is input. Then, the apparatus in related art acquires quality transition by accumulating the estimated quality of the products. Then, the apparatus in related art evaluates a quality change tendency with respect to the reference value of the quality using the acquired quality transition. Then, the apparatus in related art generates a matrix representing a relationship between the quality change tendency and the operating condition of the molding machine for restoring the quality to the reference value for each type of the molten state of the material. Then, the apparatus in related art determines the details of modification of the operating condition of the molding machine using the matrix corresponding to the molten states of the materials.

JP-A-2021-191620 is an example of the related art.

Various elements such as individual differences of molding machines themselves, new materials, molds used for molding, and installation environments of the molding machines may have an influence on an objective variable related to products such as quality of products. In consideration of the influence of these various elements on the objective variable, the relationship between the operating condition of the molding machine and the objective variable can be specified more accurately. When the technique in related art is used, it is necessary to prepare a matrix representing a relationship between the operating condition of the molding machine and the objective variable for each of various elements having the influence on the objective variable and specify the relationship between the operating condition of the molding machine and the objective variable. However, a large volume of data is required to prepare a matrix for each of various elements having the influence on the objective variable. Such a problem is not limited to the molding machine, but is common to manufacturing apparatuses other than the molding machine.

### SUMMARY

(1) According to a first aspect of the present disclosure, a data processing apparatus is provided. The data processing apparatus includes an acquisition unit that acquires a data set including two or more pieces of acquired data acquired by operating a manufacturing apparatus under a predetermined operating condition to manufacture a product in which an objective variable related to the product and a conditional variable as an explanatory variable of the objective variable representing the operating condition are associated with each other, a structuring unit that generates structured data representing a causal structure between the conditional variable and the objective variable by connecting a leaf node representing the conditional variable, a root node representing the objective variable, and an intermediate node disposed between the leaf node and the root node and representing an influential variable as the explanatory variable representing an element having an influence on the objective variable and different from the operating condition by directed edges using the data set, and a modeling unit that models the manufacturing apparatus by sequentially calculating an explanatory function as a function representing a variable of an upper node as an end point of the specific edge by using a variable of a lower node as a start point of the specific edge from the leaf node to the root node using the data set, and generating a model function as a function including the calculated explanatory function.

(2) According to a second aspect of the present disclosure, a data processing method is provided. The data processing method includes an acquisition step of acquiring a data set including two or more pieces of acquired data acquired by operating a manufacturing apparatus under a predetermined operating condition to manufacture a product in which an objective variable related to the product and a conditional variable as an explanatory variable of the objective variable representing the operating condition are associated with each other, a structuring step of generating structured data representing a causal structure between the conditional variable and the objective variable by connecting a leaf node representing the conditional variable, a root node representing the objective variable, and an intermediate node disposed between the leaf node and the root node and representing an influential variable as the explanatory variable representing an element having an influence on the objective variable and different from the operating condition by directed edges using the data set, and a modeling step of modeling the manufacturing apparatus by sequentially calculating an explanatory function as a function representing a variable of an upper node as an end point of the specific edge by using a variable of a lower node as a start point of the specific edge from the leaf node to the root node using the data set, and generating a model function as a function including the calculated explanatory function.

(3) According to a third aspect of the present disclosure, a non-transitory computer-readable storage medium storing a data processing program is provided. The data processing program is for causing a computer to execute an acquisition function of acquiring a data set including two or more pieces of acquired data acquired by operating a manufacturing apparatus under a predetermined operating condition to manufacture a product in which an objective variable related to the product and a conditional variable as an explanatory variable of the objective variable representing the operating condition are associated with each other, a structuring function of generating structured data representing a causal structure between the conditional variable and the objective variable by connecting a leaf node representing the conditional variable, a root node representing the objective variable, and an intermediate node disposed between the leaf node and the root node and representing an influential variable as the explanatory variable representing an element having an influence on the objective variable and different from the operating condition by directed edges using the data set, and a modeling function of modeling the manufacturing apparatus by sequentially calculating an explanatory function as a function representing a variable of an upper node as an end point of the specific edge by using a variable of a lower node as a start point of the specific edge from the leaf node to the root node using the data set, and generating a model function as a function including the calculated explanatory function.

### BRIEF DESCRIPTION OF THE DRAWINGS

FIG. 1 is a block diagram showing a schematic configuration of a manufacturing system.

FIG. 2 is a flowchart showing a method of manufacturing a product using an injection molding machine.

FIG. 3 is a block diagram showing a configuration of a data processing apparatus in a first embodiment.

FIG. 4 is a flowchart showing a modeling method for the injection molding machine.

FIG. 5 is a conceptual diagram of structured data.

FIG. 6 is a first diagram showing a method of calculating an explanatory function.

FIG. 7 is a second diagram showing the method of calculating the explanatory function.

FIG. 8 is a third diagram showing the method of calculating the explanatory function.

FIG. 9 shows a specific example of modeling an injection molding machine by a model function.

FIG. 10 is a block diagram showing a configuration of a data processing apparatus according to a second embodiment.

FIG. 11 is a flowchart showing a control method of the injection molding machine.

FIG. 12 is a block diagram showing a configuration of a data processing apparatus according to a third embodiment.

FIG. 13 is a conceptual diagram of structured data generated in the third embodiment.

FIG. 14 is a block diagram showing a configuration of a data processing apparatus according to a fourth embodiment.

FIG. 15 is a conceptual diagram of structured data generated in the fourth embodiment.

FIG. 16 is a block diagram showing a configuration of a data processing apparatus according to a fifth embodiment.

### DESCRIPTION OF EMBODIMENTS

### A. First Embodiment

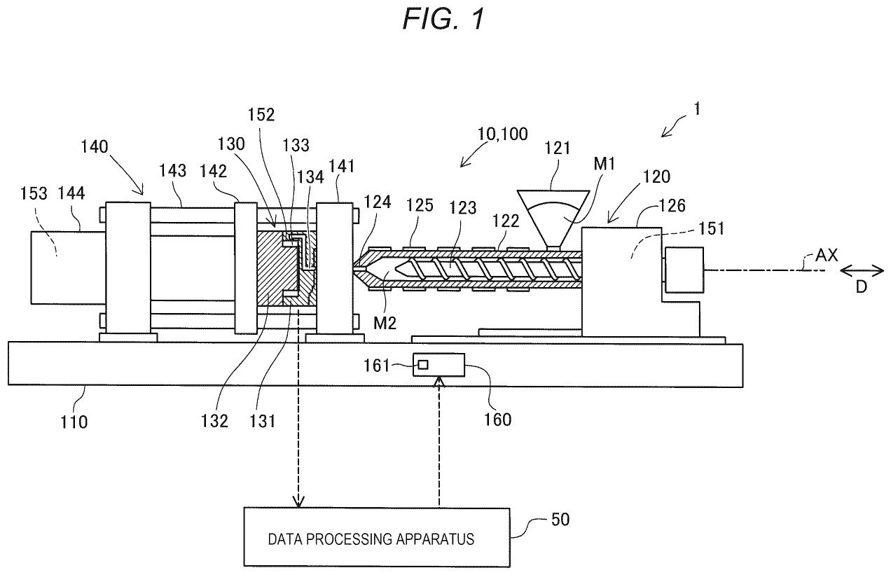

FIG. 1 is a block diagram showing a schematic configuration of a manufacturing system 1. The manufacturing system 1 is a system for determining an operating condition of a manufacturing apparatus 10 and operating the manufacturing apparatus 10 according to the determined operating condition to manufacture products. The manufacturing system 1 includes the manufacturing apparatus 10 and a data processing apparatus 50.

The manufacturing apparatus 10 manufactures products. In the present embodiment, the manufacturing apparatus 10 is an injection molding machine 100. The injection molding machine 100 includes a bed 110, an injection device 120, a mold 130, a mold clamping device 140, sensors 151 to 153, and a control device 160.

The injection device 120 is disposed on the bed 110. The injection device 120 includes a hopper 121, a heating cylinder 122, a screw 123, a nozzle 124, a heater 125, and an injection drive device 126. The hopper 121 is a material tank having an inlet for feeding a molding material M1 such as resin. The heating cylinder 122 is movable along the axial direction D with respect to the bed 110. The heating cylinder 122 pressurizes a molten material M2 generated by heating and melting the molding material M1 fed into the hopper 121. The heating cylinder 122 is also referred to as a barrel. The screw 123 is disposed inside the heating cylinder 122. The screw 123 is movable along the axial direction D while rotating around an axis AX of the heating cylinder 122. The screw 123 supplies the molten material M2 inside the heating cylinder 122 to the nozzle 124 by moving along the axial direction D of the heating cylinder 122. The nozzle 124 is provided at the tip of the heating cylinder 122. The nozzle 124 is an injection port for injecting the molten material M2 inside the heating cylinder 122 toward the mold 130. The heater 125 generates the molten material M2 by heating the molding material M1 inside the heating cylinder 122. The injection drive device 126 moves the heating cylinder 122 along the axial direction D, rotates the screw 123 around the axis AX, and moves the screw 123 along the axial direction D. The injection drive device 126 is, for example, a cylinder device.

The mold 130 includes a fixed mold 131, a movable mold 132, a cavity 133, and a supply channel 134. The cavity 133 is formed between the fixed mold 131 and the movable mold 132 by clamping the fixed mold 131 and the movable mold 132. The supply channel 134 is provided over the inside of the fixed mold 131 and the inside of a fixed platen 141 described later so that the cavity 133 and the nozzle 124 communicate with each other. The supply channel 134 is a flow path for supplying the molten material M2 injected from the nozzle 124 to the cavity 133.

The mold clamping device 140 is provided at a position facing the injection device 120 on the bed 110. The mold clamping device 140 opens and closes the attached mold 130. Further, the mold clamping device 140 clamps the mold 130 so that the mold 130 is not opened by the pressure of the molten material M2 injected into the cavity 133. The mold clamping device 140 includes the fixed platen 141, a movable platen 142, a diver 143, and a mold drive device 144. The fixed platen 141 is fixed to the fixed mold 131. The movable platen 142 is fixed to the movable mold 132. The movable platen 142 can move closer to and away from the fixed platen 141. The diver 143 movably supports the movable platen 142. The mold drive device 144 moves the movable platen 142. The mold drive device 144 is, for example, a cylinder device.

The sensors 151 to 153 acquire various physical quantities at predetermined time intervals in a period in which the injection molding machine 100 is operated. In the present embodiment, the injection molding machine 100 includes an injection device sensor 151, a mold sensor 152, and a mold clamping device sensor 153 as the sensors 151 to 153. The injection device sensor 151 acquires a physical quantity related to the injection device 120. The injection device sensor 151 acquires, for example, the injection speed of the molten material M2, the position of the heating cylinder 122 at the end of injection, the holding pressure, the pressure holding time, and the state of the injection drive device 126. The mold sensor 152 acquires a physical quantity related to the mold 130. The mold sensor 152 acquires, for example, the filling speed, the filling time, and the filling temperature of the molten material M2 in the supply channel 134. The mold clamping device sensor 153 acquires a physical quantity related to the mold clamping device 140. The mold clamping device sensor 153 acquires, for example, the mold clamping force of the mold 130, the temperature of the mold 130, and the state of the mold drive device 144. The types of the sensors 151 to 153 are not limited to those described above.

The control device 160 controls the operation of each unit of the injection molding machine 100. The control device 160 includes a communication device 161 for communicating with various devices such as the data processing apparatus 50. The control device 160 acquires an operation control signal from the data processing apparatus 50 via the communication device 161. The operation control signal is a control signal indicating an operating condition of the injection molding machine 100. The operating condition of the injection molding machine 100 is a condition that can be directly set when the injection molding machine 100 is operated. The operation control signal includes, for example, the temperature of the heating cylinder 122, the injection pressure of the molten material M2, the injection speed of the molten material M2, the holding pressure, the pressure holding time, and the rotation speed of the screw 123 as parameters representing the operating condition of the injection molding machine 100. The operation control signal may include the temperature of the nozzle 124 during injection, the position of the screw 123 at switching from injection to holding pressure, the clamping force of the mold 130, the temperature of the mold 130, and the cooling time of the mold 130 as the parameters representing the operating condition of the injection molding machine 100. The control device 160 controls operations of the injection drive device 126, the mold drive device 144, and the like using the operation control signal. Accordingly, the control device 160 operates the injection molding machine 100 under the operating condition represented by the operation control signal.

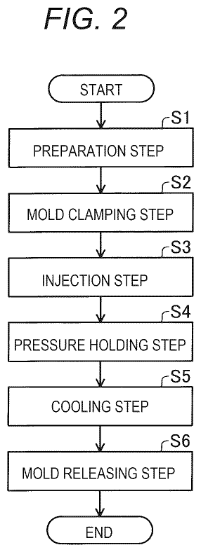

FIG. 2 is a flowchart showing a method of manufacturing a product using the injection molding machine 100. In a preparation step of step S1, the molding material M1 is melted by shear heat with the heating of the heater 125 and the rotation of the screw 123, and thereby generating the molten material M2. In a mold clamping step of step S2, the movable platen 142 is moved and the fixed mold 131 and the movable mold 132 are joined, and thereby clamping the mold 130. Further, the heating cylinder 122 is moved along the axial direction D closer to the mold clamping device 140. Thus, the nozzle 124 is coupled to the fixed platen 141 of the mold clamping device 140. In an injection step of step S3, the rotation of the screw 123 is stopped, and the screw 123 is moved toward the nozzle 124 with a predetermined pushing force. Accordingly, the molten material M2 is injected into the cavity 133 of the mold 130 at high pressure. In a pressure holding step of step S4, the predetermined pushing force is applied to the screw 123 for a predetermined pressure holding time, and thereby holding the molten material M2 in the cavity 133 at predetermined holding pressure for the predetermined pressure holding time. Accordingly, the molten material M2 is pushed into the cavity 133. In a cooling step of step S5, the pushing of the molten material M2 is stopped and the mold 130 is cooled, and thereby solidifying the molten material M2 in the cavity 133. In a mold releasing step of step S6, the fixed mold 131 and the movable mold 132 are separated, and thereby taking out a product.

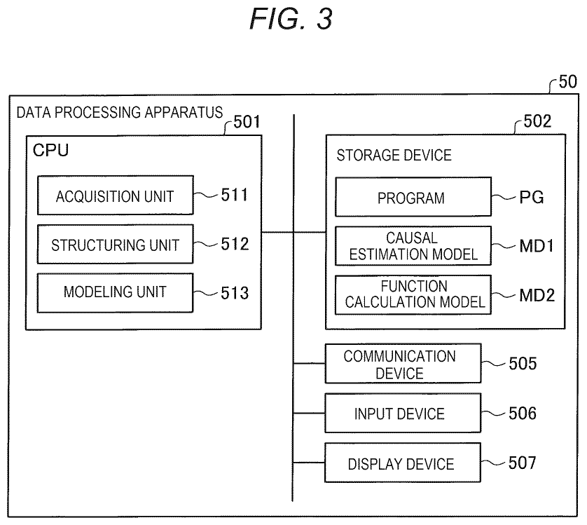

FIG. 3 is a block diagram showing a configuration of the data processing apparatus 50 in a first embodiment. The data processing apparatus 50 models the injection molding machine 100. The data processing apparatus 50 includes a computer having a CPU 501, a storage device 502, a communication device 505, an input device 506, and a display device 507. The CPU 501 functions as an acquisition unit 511, a structuring unit 512, and a modeling unit 513 by executing a program PG stored in the storage device 502. Each function of the CPU 501 will be described together with a data processing method described later. The communication device 505 can communicate with an external device by wired communication or wireless communication. The input device 506 receives input from a user. The input device 506 includes, for example, a keyboard and a mouse. The display device 507 displays various types of information. The display device 507 includes, for example, a liquid crystal display.

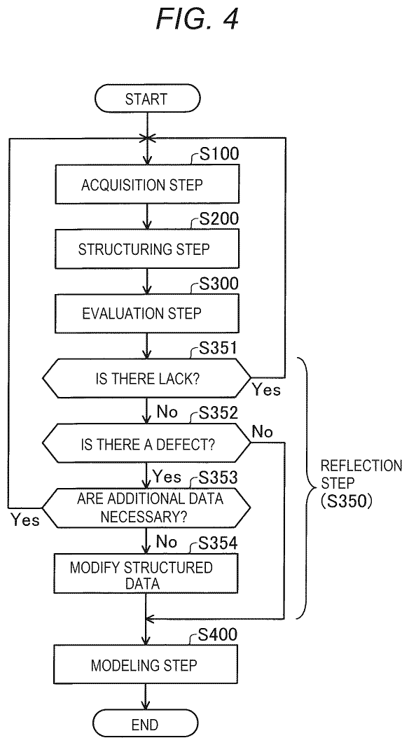

FIG. 4 is a flowchart showing a modeling method for the injection molding machine 100 as the data processing method. The modeling method for the injection molding machine 100 shown in FIG. 4 is executed, for example, when the injection molding machine 100 is modeled.

In the modeling method, first, an acquisition step of step S100 is executed. The acquisition step is a step of collecting various kinds of data used when modeling the injection molding machine 100 and acquiring a data set including the collected various kinds of data. The data set includes at least two or more pieces of acquired data. The acquired data is acquired by operating the injection molding machine 100 under the predetermined operating condition to manufacture a product. The acquired data is data in which an objective variable related to a product is associated with a conditional variable as an explanatory variable representing an operating condition of the injection molding machine 100 when the product corresponding to the objective variable is manufactured. The objective variable is, for example, quality information indicating the quality of the product. The quality information is, for example, the weight of the product. The quality information may be a dimension of the product. The quality information is acquired, for example, by inspecting a product after the product is manufactured. The objective variable may be a cycle time when the product is manufactured, or may be a variation in quality of the product. The conditional variable is, for example, a setting value of a parameter indicating an operating condition of the injection molding machine 100.

Here, there may be an element having an influence on the objective variable in addition to the operating condition of the injection molding machine 100. The element other than the operating condition having an influence on the objective variable is, for example, a result condition of the injection molding machine 100. The result condition of the injection molding machine 100 is a condition not directly settable when the injection molding machine 100 is operated. The result condition of the injection molding machine 100 is determined according to the operating condition of the injection molding machine 100, the external environment when the injection molding machine 100 is operated, the degree of deterioration of the movable part of the injection molding machine 100, the material property of the molding material M1, and the like. The parameters representing the result condition of the injection molding machine 100 are, for example, the filling time of the molten material M2, the filling pressure of the molten material M2, the gate seal position, and the position of the heating cylinder 122 at the end of injection. The parameters representing the result condition of the injection molding machine 100 can be represented by, for example, sensing data output from the sensors 151 to 153. In the present embodiment, the data set further includes sensing data output from the sensors 151 to 153 so that element other than the operating condition having an influence on the objective variable can be added in the modeling of the injection molding machine 100. The sensing data is, for example, numerical data output from the sensors 151 to 153 at specific times during a period in which the injection molding machine 100 is operated. The sensing data may be time-series data generated by arranging two or more pieces of numerical data acquired at different times in chronological order, or may be a feature value such as an average value, a maximum value, or a minimum value of the time-series data.

In the acquisition step, for example, the user determines a factor and a level and creates an experimental plan using an orthogonal array. The factor is a parameter representing the operating condition of the injection molding machine 100. The level is a setting value of the parameter representing the operating condition of the injection molding machine 100. The user sets the operating condition based on the experimental plan and operates the injection molding machine 100 to acquire the product. The user inspects the product to acquire quality information such as the weight or the dimension of the product. The user acquires the sensing data via the display device 507 or the like. The user performs the series of operations at a predetermined number of times for each level. Then, the user inputs the objective variable such as the quality information, the setting value of the parameter representing the operating condition, and the sensing data to the data processing apparatus 50 via the input device 506 in association with each product. Accordingly, the acquisition unit 511 acquires a data set in which the sensing data is associated with each of the two or more pieces of acquired data with the objective variable and the conditional variable associated with each other. At least part of the processing in the acquisition step may be executed by the acquisition unit 511. The method of acquiring the data set is not limited to that described above.

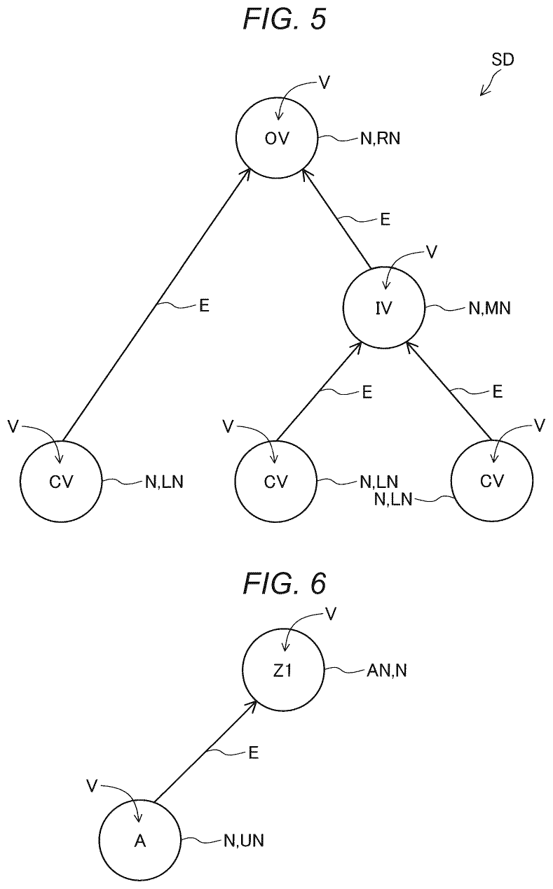

After the acquisition step, a structuring step of step S200 is executed. The structuring step is a step of generating structured data representing a causal structure between the conditional variable and the objective variable using the data set. FIG. 5 is a conceptual diagram of structured data SD. The structured data SD is, for example, a directed acyclic graph (DAG). The structured data SD is generated by connecting a leaf node LN, a root node RN, and an intermediate node MN by directed edges E. The leaf node LN is a node N whose input from another node N is not present. The leaf node LN represents a conditional variable CV. The root node RN is a node N whose output to another node N is not present. The root node RN represents an objective variable OV. The intermediate node MN is a node N placed between the leaf node LN and the root node RN. That is, the intermediate node MN is a node N whose input from another node N and output to another node N are present. The intermediate node MN represents an influential variable IV. The influential variable IV is an explanatory variable representing an element having an influence on the objective variable OV and is different from the operating condition. The influential variable IV is, for example, an actual measurement value of a parameter representing a result condition of the injection molding machine 100. The structured data SD may further include other information such as a mutual information content.

In the structuring step, the structuring unit 512 generates structured data SD. For example, the structuring unit 512 generates structured data SD by inputting a data set to a causal estimation model MD1 stored in advance in the storage device 502. The causal estimation model MD1 is a machine learning model that performs a causal structure search between variables V contained in a data set. When a data set is input, the causal estimation model MD1 outputs structured data SD. The causal estimation model MD1 sets, for example, nodes N for all variables V contained in the data set. The causal estimation model MD1 connects all the nodes N with directed edges E directed from the lower level to the upper level in the hierarchy according to the causal relationship among the nodes N. The causal estimation model MD1 calculates a correlation coefficient between nodes N connected by each edge E. By deleting the edge E whose correlation coefficient is less than a predetermined threshold, the causal estimation model MD1 generates the structured data SD having the edges E whose correlation coefficients are equal to or greater than the predetermined threshold. At least part of the processing in the structuring step may be performed by the user. For example, the user may designate which variable V is to be placed in which layer of the node N in advance via the input device 506. In this case, the structuring unit 512 generates structured data SD in which the variable V designated by the user is placed in the node N of the layer designated by the user.

As shown in FIG. 4, an evaluation step of step S300 is executed after the structuring step. The evaluation step is a step of evaluating the structured data SD by an expert. The expert is a person who has knowledge and experience about manufacturing using the injection molding machine 100. For example, the expert has knowledge that the weight of a product tends to decrease when a setting value of a parameter representing a specific operating condition is increased. The expert is, for example, an operator who operates the injection molding machine 100 and is engaged in daily manufacturing using the injection molding machine 100. The expert may be an engineer who maintains the injection molding machine 100. The experts compare their opinion with the structured data SD, and extracts a lack or defect of the structured data SD.

After the evaluation step, a reflection step of step S350 is executed. The reflection step is a step of taking measures to reflect the evaluation result by the expert in the structured data SD. When a lack of the structured data SD is not extracted by the expert, that is, when step S351 is “No”, step S352 is executed. On the other hand, when a lack of the structured data SD is extracted by the expert, that is, when step S351 is “Yes”, the process returns to the acquisition step, and the acquisition step, the structuring step, and the evaluation step are executed again. In this case, in the acquisition step, the user reviews the factor and the level, creates a new experimental plan by the orthogonal array, determines the operating condition based on the new experimental plan, and operates the injection molding machine 100 to acquire a new product. Then, the user inputs the sensing data to the data processing apparatus 50 via the input device 506 in association with the acquired data related to the new product. Accordingly, the acquisition unit 511 acquires a new data set. In the structuring step, the structuring unit 512 generates new structured data SD using the new data set. In the evaluation step, the expert evaluates the new structured data SD. The acquisition step, the structuring step, and the evaluation step are repeatedly executed until the lack of the structured data SD is no longer extracted by the expert, that is, until step S351 becomes “No”.

When a defect of the structured data SD is extracted by the expert, that is, when step S352 is “Yes”, step S353 is executed. When additional data is necessary to correct the defect of the structured data SD, that is, when step S353 is “Yes”, the process returns to the acquisition step, and the acquisition step, the structuring step, and the evaluation step are executed again. In this case, the user may take measures to eliminate the defect of the structured data SD when generating the structured data SD next time using a new data set including additional data. On the other hand, when additional data for correcting the defect of the structured data SD is unnecessary, that is, when step S353 is “No”, step S354 is executed. In step S354, the user takes measures to modify the structured data SD. Accordingly, the structuring unit 512 modifies the structured data SD according to an instruction of the user, and thereby correcting the defect of the structured data SD. The measures taken by the user when a defect of the structured data SD is extracted by the expert are exemplified below.

For example, when the factor and the result are reversed in the structured data SD in comparison with a temporal change in the internal state of the injection molding machine 100, the user takes the following measures. In this case, the user takes measures to replace the node N so that the structuring unit 512 generates structured data SD in which the node N representing the factor is placed at the lower level than the node N representing the result. For example, when the causal relationship that the injection pressure increases due to the extension of the injection stroke distance appears by the causal structure search, in the structured data SD, the node N representing the injection stroke distance is placed at the lower level than the node N representing the injection pressure. However, as the behavior of the injection molding machine 100, the injection stroke distance increases due to an increase in the injection pressure. That is, in comparison with the temporal change in the internal state of the injection molding machine 100, the increase in the injection pressure is temporally earlier than the determination of the injection stroke distance, and the factor and the result are reversed in the structured data SD. Therefore, the user takes measures to replace the node N so that the structuring unit 512 generates the structured data SD in which the node N representing the injection pressure is placed at the lower level than the node N representing the injection stroke distance.

When additional data is unnecessary to replace the node N of the structured data SD, the user designates, for example, the content of the variable V represented by the node N to be modified and the hierarchy of the node N to be modified later via the input device 506. As a result, the structuring unit 512 performs modification to replace the node N of the structured data SD so that the node N designated by the user represents the variable V designated by the user, whereby the causal structure of the structured data SD is modified. On the other hand, when additional data is necessary to replace the node N of the structured data SD, the user designates, for example, the following information via the input device 506 as prior information when the structured data SD is generated next time using a new data set. In this case, the user designates in advance the content of the variable V represented by the node N to be modified and the hierarchy of the node N to be modified. Accordingly, the structured data SD in which the nodes N are replaced is generated by the structuring unit 512 using the new data set, so that the causal structure of the structured data SD is modified.

Further, for example, in the structured data SD, when there is no edge E between the nodes N assumed to have a causal relationship and the causal relationship cannot be confirmed, the user takes the following measures. The user alters the injection molding machine 100 or adds the sensors 151 to 153 for acquisition of sensing data by which the causal relationship between the nodes N assumed to have the causal relationship can be confirmed when the injection molding machine 100 is operated next time or later in order to acquire additional data. For example, at least one of two or more nodes N assumed to have a causal relationship may be represented by a feature value of time-series data when a product is manufactured. In this case, by continuously manufacturing two or more products, two or more pieces of time-series data may be acquired as one piece of waveform data. In a case where a synchronization signal is not given to each piece of time-series data forming the waveform data, when time-series data is cut out for each product from the waveform data, an erroneous section in the waveform data may be cut out as time-series data. When an erroneous section in the waveform data is cut out as time-series data, a correct feature value may not be acquired in at least one of two or more products. In this case, the correlation coefficient between the nodes N assumed to have the causal relationship may not be correctly calculated, and the structured data SD in which there is no edge E between the nodes N assumed to have the causal relationship may be generated. In such a case, the user alters the injection molding machine 100 so that a synchronization signal is obtained when the injection molding machine 100 is operated next time or later in order to acquire additional data. In this way, the time-series data can be correctly cut out from the waveform data by the synchronization signal, and thus the correct feature value of the time-series data can be acquired. Accordingly, the structured data SD in which the edge E is added between the nodes N assumed to have the causal relationship is generated by the structuring unit 512 using the new data set, so that the causal relationship of the structured data SD is modified.

Further, for example, in the structured data SD, when there is an edge E between the nodes N assumed to have no causal relationship, the user takes measures to delete the edge E between the nodes N assumed to have no causal relationship. For example, when a first heater and a second heater are independently controlled and there is no correlation between the node N representing the variable V related to the first heater and the node N representing the variable V related to the second heater, it is assumed that the structured data SD adopts the following form. In this case, it is assumed that the structured data SD adopts a form in which there is no edge E between the node N representing the variable V related to the first heater and the node N representing the variable V related to the second heater. However, since the distance between the first heater and the second heater is short, there may be a correlation between the first heater and the second heater. As described above, due to the correlation between the first heater and the second heater, in the structured data SD, there may be an edge E between the node N representing the variable V related to the first heater and the node N representing the variable V related to the second heater. In such a case, the user takes measures to delete the edge E between the node N representing the variable V related to the first heater and the node N representing the variable V related to the second heater.

When additional data is unnecessary in order to delete part of the edges E of the structured data SD, the user designates the edge E to be deleted later via the input device 506, for example. As a result, the structuring unit 512 performs a correction of deleting the edge E designated by the user from the structured data SD, so that the causal relationship of the structured data SD is modified. On the other hand, when additional data is necessary to delete part of the edges E of the structured data SD, the user changes, for example, the hardware configuration related to the variable V represented by the node N assumed to have no causal relationship among the configurations of the injection molding machine 100. For example, when there is an edge E between the node N representing the variable V related to the first heater and the node N representing the variable V related to the second heater in the structured data SD because the distance between the first heater and the second heater is short, the user performs the following operation. In this case, the user changes the placement of at least one of the first heater and the second heater in the injection molding machine 100 to increase the distance between the first heater and the second heater. Accordingly, the structuring unit 512 generates the structured data SD in which there is no edge E between the nodes N designated by the user using the new data set, so that the causal relationship of the structured data SD is modified.

For example, when there is an edge E between the nodes N assumed to have no causal relationship, the user may take the following measures. For example, the user may take measures to add, to the structured data SD, an intermediate node MN representing a new variable V correlated with the variable V represented by at least one of two or more nodes N assumed to have no causal relationship. For example, when there is an edge E between the node N representing the variable V related to the first heater and the node N representing the variable V related to the second heater in the structured data SD because the distance between the first heater and the second heater is short, the user may take the following measures. In this case, the user may take measures to add an intermediate node MN representing an influential variable IV indicating the distance between the first heater and the second heater to the structured data SD.

When additional data is not necessary to add the intermediate node MN to the structured data SD, the user designates, for example, the content of the variable V represented by the node N to be added and the hierarchy of the node N to be added later via the input device 506. Accordingly, the structuring unit 512 generates the structured data SD in which the node N representing the variable V designated by the user is added to the layer designated by the user, so that the causal relationship of the structured data SD is modified. On the other hand, when additional data is necessary to add the intermediate node MN to the structured data SD, the user designates, for example, the following information via the input device 506 as prior information when the structured data SD is generated next time using a new data set. In this case, the user designates in advance the content of the variable V represented by the node N to be added and the hierarchy of the node N to be added. Accordingly, the structuring unit 512 generates the structured data SD to which the node N is added using the new data set, so that the causal relationship of the structured data SD is modified.

When neither a lack nor a defect of the structured data SD is extracted by the expert, that is, when both step S351 and step S352 are “No”, the completion of the structured data SD is determined, and a modeling step of step S400 is executed.

The modeling step is a step of modeling the injection molding machine 100 using the data set and the structured data SD. The edge E in the structured data SD means that some influence is exerted from the start point side to the end point side. Therefore, in the modeling g step, the modeling unit 513 sequentially calculates an explanatory function, which is a function representing the variable V of the upper node as the end point of the specific edge E using the lower node as the start point of the specific edge E, from the leaf node LN to the root node RN. That is, the modeling unit 513 calculates an explanatory function for each layer in the structured data SD. Then, the modeling unit 513 models the injection molding machine 100 by generating a model function as a function including the calculated explanatory function. That is, the model function is a function in which the edge E is regarded as propagation of a numerical value.

FIG. 6 shows a method of calculating an explanatory function of a layer having an edge E connected from one lower node UN to one upper node AN. A first upper variable 21 as the variable V represented by the upper node AN can be represented by, for example, the following Expression (1) using a first lower variable A as the variable V represented by the lower node UN.

$$Z 1 = kA \cdot k + t 1 \qquad Expression ( 1 )$$

In Expression (1), the first single coefficient kA is a coefficient representing an influence of the first lower variable A alone on the first upper variable Z1. A first constant t1 is a constant representing the influence of the first lower variable A alone on the first upper variable Z1.

The modeling unit 513 first calculates the first single coefficient kA and the first constant t1. The modeling unit 513 calculates the first single coefficient kA and the first constant t1 using, for example, a function calculation model MD2 stored in advance in the storage device 502. The function calculation model MD2 is a machine learning model that calculates a coefficient and a constant of a function representing a causal relationship between the lower node UN and the upper node AN as in Expression (1). When the variable V represented by the lower node UN and the variable V represented by the upper node AN are input, the function calculation model MD2 outputs a coefficient and a constant representing the influence of the variable V of the lower node UN on the variable V of the upper node AN. The function calculation model MD2 calculates a coefficient and a constant representing the influence of the variable V of the lower node UN on the variable V of the upper node AN by approximating the variable V by, for example, the least squares method. The modeling unit 513 inputs the first lower variable A and the first upper variable Z1 contained in the data set to the function calculation model MD2. Thus, the modeling unit 513 calculates the first single coefficient kA and the first constant t1.

Then, the modeling unit 513 calculates an explanatory function representing the first upper variable 21 by the first lower variable A and the calculated coefficient kA and constant t1. The modeling unit 513 calculates, for example, an explanatory function as shown by the following Expression (2). Specifically, the modeling unit 513 generates a term of multiplication of the first single coefficient kA by the first lower variable A. Further, the modeling unit 513 calculates an explanatory function representing a first relationship value F1 by a mathematical expression obtained by adding the first constant t1 to the term.

$$F 1 = kA \cdot A + t 1 \qquad Expression ( 2 )$$

In Expression (2), the first relationship value F1 is an index representing the relationship between the first lower variable A and the first upper variable Z1.

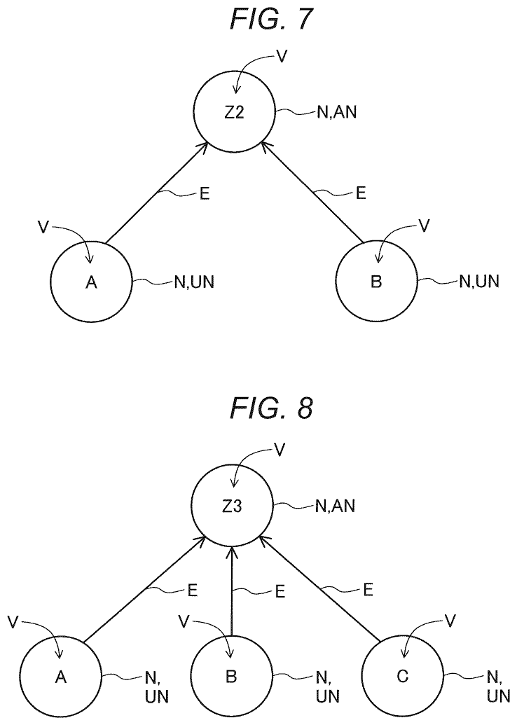

FIG. 7 shows a method of calculating an explanatory function of a layer having edges E connected from two lower nodes UN to one upper node AN. A second upper variable Z2 as the variable V represented by the upper node AN can be represented by, for example, the following Expression (3) using the first lower variable A and a second lower variable B as the variables V respectively represented by the two lower nodes UN.

$$Z 2 = kA \cdot A + kB \cdot B + kAB \cdot A \cdot B + t 2 \qquad Expression ( 3 )$$

In Expression (3), the first single coefficient kA is a coefficient representing an influence of the first lower variable A alone on the second upper variable Z2. A second single coefficient kB is a coefficient representing an influence of the second lower variable B alone on the second upper variable Z2. A first mutual coefficient kAB is a coefficient representing an influence of the interaction between the first lower variable A and the second lower variable B on the second upper variable Z2. A second constant t2 is a constant representing an influence of the first lower variable A and the second lower variable B on the second upper variable Z2.

The modeling unit 513 first inputs the first lower variable A, the second lower variable B, and the second upper variable Z2 contained in the data set to the function calculation model MD2. Thus, the modeling unit 513 calculates the first single coefficient kA, the second single coefficient kB, the first mutual coefficient kAB, and the second constant t2. Then, the modeling unit 513 calculates an explanatory function representing the second upper variable 22 by the first lower variable A, the second lower variable B, the calculated coefficients kA, kB, KAB, and constant t2. The modeling unit 513 calculates, for example, an explanatory function as shown in the following Expression (4). Specifically, the modeling 513 unit generates a term of multiplication of the first single coefficient kA by the first lower variable A and a term of multiplication of the second single coefficient kB by the second lower variable B. Further, the modeling unit 513 generates a term of multiplication of the first mutual coefficient kAB by the first lower variable A and the second lower variable B. Then, the modeling unit 513 calculates an explanatory function representing a second relationship value F2 by a mathematical expression obtained by adding the second constant t2 to these terms.

$$F 2 = kA \cdot A + kB \cdot B + kAB \cdot A \cdot B + t 2 \qquad Expression ( 4 )$$

In Expression (4), the second relationship value F2 is an index representing the relationship between the first lower variable A and the second lower variable B, and the second upper variable Z2.

FIG. 8 shows a method of calculating an explanatory function of a layer having edges E connected from three lower nodes UN to one upper node AN. A third upper variable Z3 as the variable V represented by the upper node AN can be represented by, for example, the following Expression (5) using the first lower variable A, the second lower variable B, and a third lower variable C as the variables V respectively represented by the three lower nodes UN.

$$Z 3 = kA \cdot A + kB \cdot B + kC \cdot C + kAB \cdot A \cdot B + kBC \cdot B \cdot C + kCA \cdot C \cdot A + t 3 \qquad Expression ( 5 )$$

In Expression (5), the first single coefficient kA is a coefficient representing an influence of the first lower variable A alone on the third upper variable Z3. A second single coefficient kB is a coefficient representing an influence of the second lower variable B alone on the third upper variable Z3. A third single coefficient kC is a coefficient representing an influence of the third lower variable C alone on the third upper variable Z3. A first mutual coefficient kAB is a coefficient representing an influence of the interaction between the first lower variable A and the second lower variable B on the third upper variable Z3. A second mutual coefficient kBC is a coefficient representing an influence of the interaction between the second lower variable B and the third lower variable C on the third upper variable Z3. A third mutual coefficient kCA is a coefficient representing an influence of the interaction between the third lower variable C and the first lower variable A on the third upper variable Z3. A third constant t3 is a constant representing an influence of the first lower variable A, the second lower variable B, and the third lower variable C on the third upper variable Z3.

The modeling unit 513 first inputs the first lower variable A, the second lower variable B, the third lower variable C, and the third upper variable Z3 contained in the data set to the function calculation model MD2. Accordingly, the modeling unit 513 calculates the first single coefficient kA, the second single coefficient kB, the third single coefficient kC, the first mutual coefficient kAB, the second mutual coefficient kBC, the third mutual coefficient kCA, and the third constant t3. Then, the modeling unit 513 calculates an explanatory function representing the third upper variable 23 by the first lower variable A, the second lower variable B, the third lower variable C, the calculated coefficients kA, kB, kC, kAB, kBC, kCA, and constant t3. The modeling unit 513 calculates, for example, an explanatory function as shown in the following Expression (6). Specifically, the modeling unit 513 generates a term of multiplication of the first single coefficient kA by the first lower variable A, a term of multiplication of the second single coefficient kB by the second lower variable B, and a term of multiplication of the third single coefficient kC by the third lower variable C. Further, the modeling unit 513 generates a term of multiplication of the first mutual coefficient kAB by the first lower variable A and the second lower variable B, a term of multiplication of the second mutual coefficient kBC by the second lower variable B and the third lower variable C, and a term of multiplication of the third mutual coefficient kCA by the third lower variable C and the first lower variable A. Then, the modeling unit 513 calculates an explanatory function representing a third relationship value F3 by a mathematical expression obtained by adding the third constant t3 to these terms.

$$F 3 = kA \cdot A + kB \cdot B + kC \cdot C + kAB \cdot A \cdot B + kBC \cdot B \cdot C + kCA \cdot C \cdot A + t 3 \qquad Expression ( 6 )$$

In Expression (6), the third relationship value F3 is an index representing the relationship between the first lower variable A, the second lower variable B, and the third lower variable C, and the third upper variable Z3.

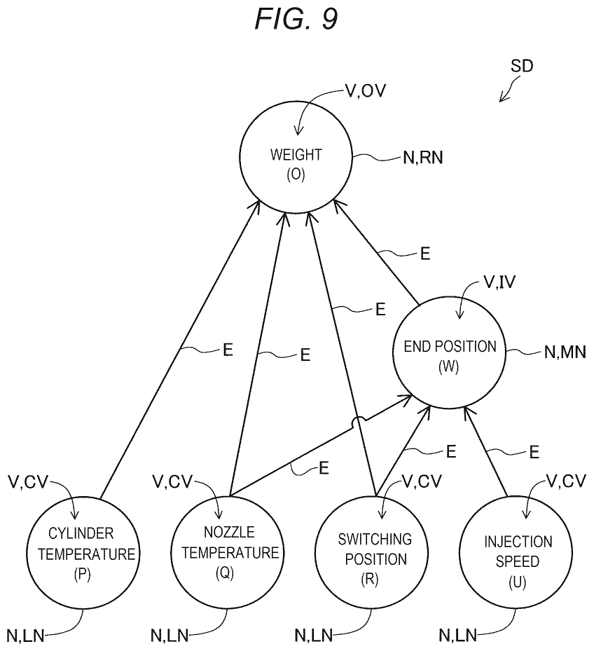

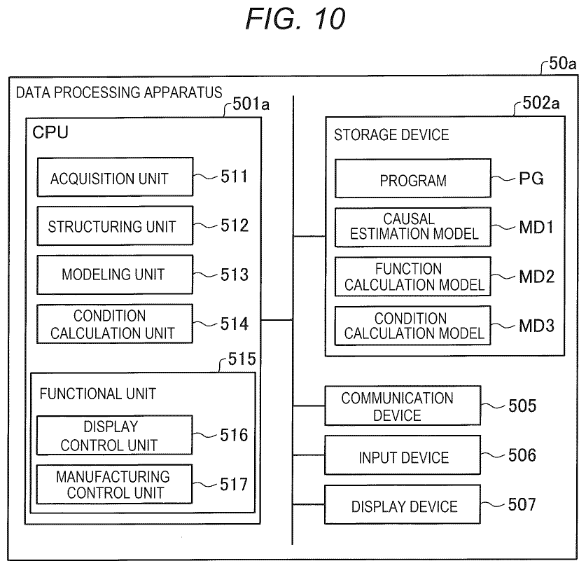

FIG. 9 shows a specific example of modeling the injection molding machine 100 by a model function. FIG. 9 illustrates an example of structured data SD related to the injection molding machine 100. In the example shown in FIG. 9, conditional variables CV represented by leaf nodes LN are a temperature P of the heating cylinder 122, a temperature Q of the nozzle 124, a position R of the screw 123 at switching from injection to holding pressure, and an injection speed U of the molten material M2. An influential variable IV represented by an intermediate node MN is a position W of the heating cylinder 122 at the end of injection. An objective variable OV represented by a root node RN is a weight O of a product.

The position W of the heating cylinder 122 at the end of injection can be expressed by, for example, the following Expression (7) using the temperature Q of the nozzle 124, the position R of the screw 123 at switching from injection to holding pressure, and the injection speed U of the molten material M2 connected by the edges E.

$$W = kQ 1 \cdot Q + kR 1 \cdot R + kU \cdot U + kQR 1 \cdot Q \cdot R + kRU \cdot R \cdot U + kUQ \cdot U \cdot Q + t 4 \qquad Expression ( 7 )$$

In Expression (7), a fourth single coefficient kQ1 is a coefficient representing an influence of the temperature Q of the nozzle 124 on the position W of the heating cylinder 122 at the end of injection. A fifth single coefficient kR1 is a coefficient representing an influence of the position R of the screw 123 at switching from injection to holding pressure on the position W of the heating cylinder 122 at the end of injection. A sixth single coefficient kU is a coefficient representing an influence of the injection speed U of the molten material M2 on the position W of the heating cylinder 122 at the end of injection. A fourth mutual coefficient kQR1 is a coefficient representing an influence of the interaction between the temperature Q of the nozzle 124 and the position R of the screw 123 at switching from injection to holding pressure on the position W of the heating cylinder 122 at the end of injection. A fifth mutual coefficient KRU is a coefficient representing an influence of the interaction between the position R of the screw 123 and the injection speed U of the molten material M2 at switching from injection to holding pressure on the position W of the heating cylinder 122 at the end of injection. A sixth mutual coefficient kUQ is a coefficient representing an influence of the interaction between the injection speed U of the molten material M2 and the temperature Q of the nozzle 124 on the position W of the heating cylinder 122 at the end of injection. A fourth constant t4 is a constant representing an influence of the temperature Q of the nozzle 124, the position R of the screw 123 at switching from injection to holding pressure, and the injection speed U of the molten material M2 on the position W of the heating cylinder 122 at the end of injection.

A weight O of a product can be expressed by, for example, the following Expression (8) using the temperature P of the heating cylinder 122, the temperature Q of the nozzle 124, the position R of the screw 123, and the position W of the heating cylinder 122 connected by the edges E.

$$O = kP \cdot P + kQ 2 \cdot Q + kR 2 \cdot R + kW \cdot W + kPQ \cdot P \cdot Q + kQR 2 \cdot Q \cdot R + kRW \cdot R \cdot W + kWP \cdot W \cdot P + t 5 \qquad Expression ( 8 )$$

In Expression (8), a seventh single coefficient kP is a coefficient representing an influence of the temperature P of the heating cylinder 122 on the weight O of the product. An eighth single coefficient kQ2 is a coefficient representing an influence of the temperature Q of the nozzle 124 on the weight O of the product. A ninth single coefficient kR2 is a coefficient representing an influence of the position R of the screw 123 at switching from injection to holding pressure on the weight O of the product. A tenth single coefficient kW is a coefficient representing an influence of the position W of the heating cylinder 122 at the end of injection on the weight O of the product. A seventh mutual coefficient kPQ is a coefficient representing an influence of the interaction between the temperature P of the heating cylinder 122 and the temperature Q of the nozzle 124 on the weight O of the product. An eighth mutual coefficient kQR2 is a coefficient representing an influence of the interaction between the temperature Q of the nozzle 124 and the position R of the screw 123 at switching from injection to holding pressure on the weight O of the product. A ninth mutual coefficient kRW is a coefficient representing an influence of the interaction between the position R of the screw 123 at switching from injection to holding pressure and the position W of the heating cylinder 122 at the end of injection on the weight O of the product. A tenth mutual coefficient kWP is a coefficient representing an influence of the interaction between the position W of the heating cylinder 122 and the temperature P of the heating cylinder 122 at the end of injection on the weight O of the product. A fifth constant t5 is a constant representing an influence of the temperature P of the heating cylinder 122, the temperature Q of the nozzle 124, the position R of the screw 123 at switching from injection to holding pressure, and the position W of the heating cylinder 122 at the end of injection on the weight O of the product.

The modeling unit 513 inputs the temperature P of the heating cylinder 122, the temperature Q of the nozzle 124, the position R of the screw 123 at switching from injection to holding pressure, the injection speed U of the molten material M2, and the weight O of the product contained in the data set to the function calculation model MD2. Accordingly, the modeling unit 513 calculates the fourth single coefficient kQ1, the fifth single coefficient kR1, the sixth single coefficient kU, the seventh single coefficient kP, the eighth single coefficient kQ2, the ninth single coefficient kR2, and the tenth single coefficient kW. Further, the modeling unit 513 calculates the fourth mutual coefficient kQR1, the fifth mutual coefficient kRU, the sixth mutual coefficient kUQ, the seventh mutual coefficient kPQ, the eighth mutual coefficient kQR2, the ninth mutual coefficient kRW, and the tenth mutual coefficient kWP. Furthermore, the modeling unit 513 calculates the fourth constant t4 and the fifth constant t5. By calculating the coefficients kQ1, kR1, KU, kP, kQ2, KR2, KW, kQR1, KRU, KUQ, kPQ, KQR2, KRW, and kWP and the constants t4 and t5 in this manner, the modeling unit 513 generates a model function MF below. The model function MF representing the weight O of the product is generated by the temperature P and the position R of the heating cylinder 122, the temperature Q of the nozzle 124, the position W of the screw 123, the calculated coefficients kP, kQ2, kR2, KW, kPQ, kQR2, KRW, kWP, and constant t5. The modeling unit 513 generates, for example, a model function MF as shown in the following Expression (9). Specifically, the modeling unit 513 generates a term of multiplication of the seventh single coefficient kP by the temperature P of the heating cylinder 122 and a term of multiplication of the eighth single coefficient kQ2 by the temperature Q of the nozzle 124. Further, the modeling unit 513 generates a term of multiplication of the ninth single coefficient kR2 by the position R of the screw 123 at switching from injection to holding pressure, and a term of multiplication of the tenth single coefficient kW by the position W of the heating cylinder 122 at the end of injection. Furthermore, the modeling unit 513 generates a term of multiplication of the seventh mutual coefficient kPQ by the temperature P of the heating cylinder 122 and the temperature Q of the nozzle 124. The modeling unit 513 generates a term of multiplication of the eighth mutual coefficient kQR2 by the temperature Q of the nozzle 124 and the position R of the screw 123 at switching from injection to holding pressure. Further, the modeling unit 513 generates a term of multiplication of the ninth mutual coefficient kRW by the position R of the screw 123 at switching from injection to holding pressure and the position W of the heating cylinder 122 at the end of injection. Furthermore, the modeling unit 513 generates a term of multiplication of the tenth mutual coefficient kWP by the position W of the heating cylinder 122 and the temperature P of the heating cylinder 122 at the end of injection. Then, the modeling unit 513 generates a mathematical expression obtained by adding the fifth constant t5 to these terms as the model function MF.

$$MF = kP \cdot P + kQ 2 \cdot Q + kR 2 \cdot R + kW \cdot W + kPQ \cdot P \cdot Q + kQR 2 \cdot Q \cdot R + kRW \cdot R \cdot W + kWP \cdot W \cdot P + t 5 \qquad Expression ( 9 )$$

The position W of the heating cylinder 122 shown in Expression (9) can be expressed by the temperature Q of the nozzle 124, the position R of the screw 123, the injection speed U of the molten material M2, the coefficients kQ1, kR1, KU, kQR1, KRU, kUQ, and the constant t4 as in Expression (7). Therefore, the model function MF shown in Expression (9) includes an explanatory function shown in the following Expression (10).

$$F 4 = kQ 1 \cdot Q + kR 1 \cdot R + kU \cdot U + kQR 1 \cdot Q \cdot R + kRU \cdot R \cdot U + kUQ \cdot U \cdot Q + t 4 \qquad Expression ( 10 )$$

In Expression (10), a fourth relationship value F4 is an index representing the relationship between the temperature Q of the nozzle 124 and the position R of the screw 123 at switching from injection to holding pressure, and the injection speed U of the molten material M2 and the position W of the heating cylinder 122 at the end of injection. When calculating the fourth relationship value F4, the modeling unit 513 generates a term of multiplication of the fourth single coefficient kQ1 by the temperature Q of the nozzle 124, a term of multiplication of the fifth single coefficient kR1 by the position R of the screw 123 at switching from injection to holding pressure, and a term of multiplication of the sixth single coefficient kU by the injection speed U of the molten material M2. Further, the modeling unit 513 generates a term of multiplication of the fourth mutual coefficient kQR1 by the temperature Q of the nozzle 124 and the position R of the screw 123 at switching from injection to holding pressure. Furthermore, the modeling unit 513 generates a term of multiplication of the fifth mutual coefficient kRU by the position R of the screw 123 at switching from injection to holding pressure and the injection speed U of the molten material M2. Moreover, the modeling unit 513 generates a term of multiplication of the sixth mutual coefficient kUQ by the injection speed U of the molten material M2 and the temperature Q of the nozzle 124. Then, the modeling unit 513 calculates an explanatory function representing the fourth relationship value F4 by a mathematical expression obtained by adding the fourth constant t4 to these terms.

According to the first embodiment, the data processing apparatus 50 can acquire the data set including two or more pieces of acquisition data in which the conditional variable CV representing the operating condition of the injection molding machine 100 and the objective variable OV related to the product are associated with each other. Then, the data processing apparatus 50 can generate structured data SD representing the causal structure between the conditional variable CV and the objective variable OV by performing the causal structure search using the data set and connecting the nodes N by the directed edges E. Then, the data processing apparatus 50 uses the data set and the structured data SD to calculate the explanatory function representing the variable V of the upper node AN using the variable V of the lower node UN in order from the lower level to the upper level of the hierarchy from the leaf nodes LN to the root node RN. Then, the data processing apparatus 50 generates the model function MF as the function including the calculated explanatory function. Accordingly, the data processing apparatus 50 can specify the relationship between the operating condition of the injection molding machine 100 and the objective variable OV by representing the relationship between the conditional variable CV and the objective variable OV by the model function MF. Concurrently, the data processing apparatus 50 calculates explanatory functions in order from the leaf nodes LN toward the upper level of the hierarchy. Therefore, the data processing apparatus 50 can represent the influential variable IV representing the element that has the influence on the objective variable OV using the conditional variable CV as shown in Expression (10). That is, the data processing apparatus 50 can quantitatively represent various elements having influences on the objective variable OV by the conditional variable CV. Therefore, the data processing apparatus 50 can specify the relationship between the operating condition of the injection molding machine 100 and the objective variable OV without acquiring a large volume of data and preparing a matrix for each of various elements having influences on the objective variable OV.

According to the first embodiment, the influential variable IV can be expressed by using the conditional variable CV as shown in Expression (10). That is, when the model function MF is generated, there may not necessarily be the influential variable IV as an actual measurement value such as sensing data. Therefore, even when the influential variable IV cannot be uniquely represented by the sensing data or the like for the node N assumed to be present as the intermediate node MN, the data processing apparatus 50 can generate the model function MF in the following manner, for example. In the reflection step illustrated in FIG. 4, the user takes measures to add the node N assumed to be present as the intermediate node MN as a dummy intermediate node MN. Further, the user takes measures to connect edges E input to and output from the added intermediate node MN from all the assumed nodes N. In the structuring step, the data processing apparatus 50 deletes unnecessary edges E among the edges E input to and output from the added intermediate node MN by deleting edges E whose correlation coefficients are less than the predetermined threshold. Using the structured data SD generated in this manner, the data processing apparatus 50 calculates explanatory functions representing the variable V of the upper node AN as the end point of the specific edge E using the lower node UN as the start point of the specific edge E in order from the leaf nodes LN to the root node RN. As a result, even when the influential variable IV cannot be uniquely represented, the data processing apparatus 50 can generate the model function MF.

According to the first embodiment, after specifying the causal relationship among the conditional variable CV, the influential variable IV, and the objective variable OV, the data processing apparatus 50 can specify the relationship between the operating condition of the injection molding machine 100 and the objective variable OV based on the specified causal relationship. Therefore, the data processing apparatus 50 can specify the relationship between the operating condition of the injection molding machine 100 and the objective variable OV without acquiring and learning a large volume of data as in deep learning.

According to the first embodiment, the data processing apparatus 50 can calculate an explanatory function of a predetermined order or less. Specifically, the data processing apparatus 50 can generate a linear explanatory function composed of addition and multiplication, for example, as shown in Expression (4). As described above, the data processing apparatus 50 can represent the relationship between the operating condition of the injection molding machine 100 and the objective variable OV using a simpler function by calculating an explanatory function of a predetermined order or less without performing a simulation of reproducing a physical phenomenon.

In the first embodiment, the data processing apparatus 50 calculates the linear explanatory function, but the present disclosure is not limited thereto. For example, the data processing apparatus 50 may calculate an explanatory function of a second or higher order representing the fifth relationship value F5 as shown in the following Expression (11).

$$F 5 = kA 2 \cdot {A}^{2} + kA 1 \cdot A \qquad Expression ( 11 )$$

In Expression (11), an eleventh single coefficient kA2 is a coefficient representing an influence of the value Ac obtained by squaring the first lower variable A alone on the upper variables Z1 to Z3. A twelfth single coefficient kA1 is a coefficient representing an influence of the first lower variable A alone on the upper variables Z1 to Z3. A fifth relationship value F5 is an index representing the relationship between the first lower variable A and the upper variables Z1 to Z3. According to the configuration, the data processing apparatus 50 can more accurately express the relationship between the operating condition of the injection molding machine 100 and the objective variable OV.

According to the first embodiment, when there are two or more lower nodes UN for the upper node AN in the structured data SD, the data processing apparatus 50 can generate the following model function MF. As shown in Expression (9), the data processing apparatus 50 can generate the model function MF including the explanatory function representing the influence of each of the two or more lower nodes UN on the upper node AN and the explanatory function representing the influence of the interaction between the two or more lower nodes UN on the upper node AN. According to the configuration, the data processing apparatus 50 can represent both the influence of one lower node UN on the upper node AN and the influence of the interaction between two or more lower nodes UN on the upper node AN by the model function MF.

According to the first embodiment, the data processing apparatus 50 can generate the model function MF including the explanatory function representing the influence of the interaction between the predetermined number of lower nodes UN on the upper node AN. According to the configuration, the data processing apparatus 50 can suppress an increase in the processing load in the process of generating the model function MF or complication of the model function MF.

The model function MF may include an explanatory function representing the influence of the interaction between the lower nodes UN on the upper node AN without including an explanatory function representing the influence of each of the two or more lower nodes UN on the upper node AN. Alternatively, the model function MF may include an explanatory function representing the influence of each of the two or more lower nodes UN on the upper node AN without including an explanatory function representing the influence of the interaction between the lower nodes UN on the upper node AN.

### B. Second Embodiment

FIG. 10 is a block diagram showing a configuration of a data processing apparatus 50a according to a second embodiment. When the external environment including the temperature, the humidity, and the atmospheric pressure at the time of manufacturing the product changes over time, the change in the external environment may have an influence on the objective variable OV. For example, the weight of the product may change over time due to the influence of the outside air temperature on the water temperature. When the movable part of the injection molding machine 100 deteriorates over time due to wear or the like, the movable part is replaced, or the movable part is repaired, the state of the movable part of the injection molding machine 100 may have an influence on the objective variable OV. For example, when the movable part of the injection molding machine 100 is replaced with a new one or when the movable part is maintained by overhaul, clogging may occur in proportion to a logarithmic function as the number of manufactured products increases. When clogging occurs in proportion to the logarithmic function as the number of manufactured products increases, the number of manufactured products per unit time or the cycle time may change over time. When the material property changes over time, the difference in material property may have an influence on the objective variable OV. For example, when the lot or the storage condition of the molding material M1 to be used is different, the quality of the product may vary over time due to a difference in viscosity or moisture content of the molding material M1. As described above, in the process of manufacturing the product, the manufacturing of the product that satisfies a predetermined threshold range of the objective variable OV may be difficult. When the objective variable OV deviates from a threshold range including a predetermined reference value in the process of manufacturing the product, it is preferable to correct the deviation of the objective variable OV from the reference value by modifying the operating condition of the injection molding machine 100 such that the objective variable OV is within the threshold range. Therefore, in the present embodiment, the data processing apparatus 50a further has a function of modifying the operating condition of the injection molding machine 100. The other configurations are the same as those of the first embodiment unless specifically explained otherwise. The same configurations as those of the first embodiment will have the same signs, and the description thereof will be omitted.

The data processing apparatus 50a includes a computer having a CPU 501a, a storage device 502a, the communication device 505, the input device 506, and the display device 507. The CPU 501a functions as the acquisition unit 511, the structuring unit 512, the modeling unit 513, a condition calculation unit 514, a display control unit 516 and a manufacturing control unit 517 as a functional unit 515 by executing a program PG stored in the storage device 502a. Each function of CPU 501a will be described together with the following data processing method.

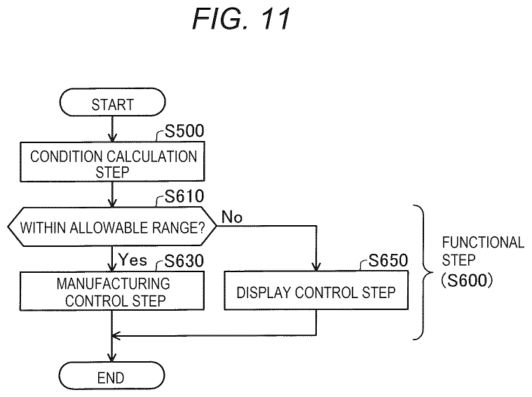

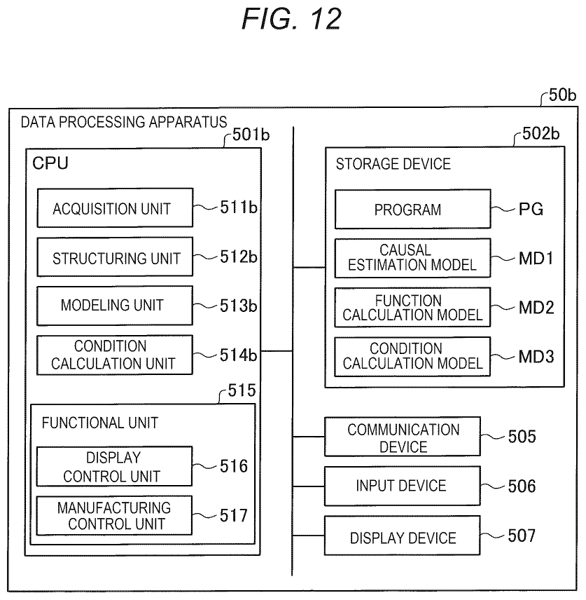

FIG. 11 is a flowchart showing a control method for the injection molding machine 100 as a data processing method. For example, the user detects that the objective variable OV deviates from the threshold range according to the transition of the objective variable OV when two or more products are manufactured. Then, the user inputs information indicating that the objective variable OV deviates from the threshold range via the input device 506. Accordingly, the data processing apparatus 50 detects that the objective variable OV deviates from the threshold range by receiving the input from the user. The data processing apparatus 50 may automatically detect that the objective variable OV deviates from the threshold range using various data such as sensing data acquired from the injection molding machine 100 without receiving input from the user. When the apparatus detects that the objective variable OV deviates from the threshold range, the control method for the injection molding machine 100 shown in FIG. 11 is executed.

In the control method for the injection molding machine 100, first, a condition calculation step of step S500 is executed. The condition calculation step is a step of calculating a new operating condition of the injection molding machine 100 using the model function MF in order to bring the objective variable OV that has changed over time close to the reference value. In the condition calculation step, the condition calculation unit 514 substitutes a conditional variable CV representing an optional operating condition different from the current operating condition of the injection molding machine 100 into the model function MF. Accordingly, the condition calculation unit 514 predicts the objective variable OV for the product manufactured by operating the injection molding machine 100 under the optional operating condition. While repeating this operation, the condition calculation unit 514 searches for an operating condition that can bring the predicted value of the objective variable OV close to a predetermined value related to the reference value. Accordingly, the condition calculation unit 514 calculates, as a new operating condition of the injection molding machine 100, an operating condition under which the objective variable OV that has changed over time can be brought closer to the reference value, that is, the objective variable OV that has changed over time can be restored to the reference value.

The condition calculation unit 514 calculates a new operating condition of the injection molding machine 100 using, for example, a condition calculation model MD3 stored in advance in the storage device 502. The condition calculation model MD3 is a machine learning model that calculates an optimal operating condition according to the reference value of the objective variable OV. When the predetermined value related to the reference value of the objective variable OV is input, the condition calculation model MD3 outputs a setting value of a new operating condition of the injection molding machine 100. As an algorithm of the condition calculation model MD3, various optimization algorithms for calculating an optimum solution can be used, and for example, the Newton method, the steepest descent method, the amoeba method, the swarm intelligence, the evolutionary algorithm, or the like can be used.

For example, in a case where the objective variable OV is the weight of the product and the reference value of the weight of the product is 10 g, when the weight of the product decreases to 8 g over time, it is necessary to increase the weight of the product by 2 g in order to bring the weight of the product close to the reference value. For example, in the case where the objective variable OV is the weight of the product and the reference value of the weight of the product is 10 g, when the weight of the product increases to 12 g over time, it is necessary to reduce the weight of the product by 2 g in order to bring the weight of the product close to the reference value. Here, actually, in a case where the weight of the product changes over time without changing the operating condition of the injection molding machine 100, when the condition calculation model MD3 uses the model function MF without addition of an element representing the change over time, the following information is merely output from the condition calculation model MD3. In this case, even when 10 g, which is the reference value of the weight of the product, is input to the condition calculation model MD3, the setting value of the current operating condition is merely output from the condition calculation model MD3. That is, as long as the reference value of the weight of the product is the same, the operating condition of the injection molding machine 100 specified using the model function MF is constant. Therefore, when the condition calculation model MD3 uses the model function MF without addition of an element representing the change over time, the condition calculation unit 514 inputs a value obtained by reflecting the difference between the objective variable OV changed over time and the reference value to the condition calculation model MD3 as the predetermined value related to the reference value of the objective variable OV. Specifically, when the weight of the product decreases from 10 g as the reference value to 8 g over time, the condition calculation unit 514 inputs 12 g obtained by adding 2 g as the difference from the reference value to 10 g as the reference value to the condition calculation model MD3. When the weight of the product increases over time from 10 g as the reference value to 12 g, the condition calculation unit 514 inputs 8 g obtained by subtracting 2 g as the difference from the reference value from 10 g as the reference value to the condition calculation model MD3. In this way, the condition calculation unit 514 can calculate a new operating condition of the injection molding machine 100 using the model function MF without addition of an element representing the change over time.

The operating conditions of the injection molding machine 100 may include an upper limit value and a lower limit value that can be set as setting values. Therefore, when the calculated new operating condition is outside the allowable range determined according to the upper limit value and the lower limit value that can be set as the operating condition of the injection molding machine 100, the condition calculation unit 514 may output error information via the display device 507 or the like. According to the configuration, the user can detect an abnormality during manufacturing.

Further, the condition calculation unit 514 may calculate a new operating condition so as to be within the allowable range. According to the configuration, the condition calculation unit 514 can be prevented from calculating an unrealistic operating condition.

Furthermore, the condition calculation unit 514 may output information indicating a preference order of the operating condition to be changed among a plurality of operating conditions as supplementary information of a new operating condition. The preference order of the operating conditions is determined according to, for example, the time required for the actual measurement value to change with the change of the setting value of the operating condition. For example, when the objective variable OV can be brought close to the reference value by changing the setting value of one of the injection pressure and the temperature of each part of the injection molding machine 100 as the operating conditions, the condition calculation unit 514 performs the following operation. When two or more products are continuously manufactured, the injection pressure can be changed for each shot. As a result, the injection pressure can be changed immediately at the time of manufacturing the next product. On the other hand, time may be required until the temperature of each part of the injection molding machine 100 changes to a desired temperature. Accordingly, the condition calculation unit 514 outputs the supplementary information so as to change the setting value of the injection pressure. According to the configuration, the time required for waiting for manufacturing the product having the objective variable OV within the threshold range can be shortened. Accordingly, a decrease in manufacturing efficiency can be suppressed.

After the condition calculation step, a functional step of S600 is executed. The functional step is a step executed when a new operating condition of the injection molding machine 100 is calculated.

When the new operating condition of the injection molding machine 100 calculated in the condition calculation step is within the preset allowable range, that is, when step S610 is “YES”, a manufacturing control step of step S630 is executed. The manufacturing control step is a step of operating the injection molding machine 100 under the new operating condition calculated in the condition calculation step. In the manufacturing control step, the manufacturing control unit 517 generates an operation control signal representing the new operating condition calculated in the condition calculation step. Then, the manufacturing control unit 517 transmits the generated operation control signal to the injection molding machine 100. Accordingly, the manufacturing control unit 517 operates the injection molding machine 100 under the new operating condition.

When the new operating condition of the injection molding machine 100 calculated in the condition calculation step is outside the allowable range, that is, when step S610 is “No”, a display control step of step S650 is executed. The display control step is a step of prompting the user of the injection molding machine 100 to change the operating condition of the injection molding machine 100 by displaying the new operating condition calculated in the condition calculation step on the display device 507. In the display control step, the display control unit 516 prompts the user of the injection molding machine 100 to change the operating condition of the injection molding machine 100 by displaying the new operating condition calculated in the condition calculation step on the display device 507. For example, the user sets a value within the allowable range according to the new operating condition displayed on the display device 507. Accordingly, the display control unit 516 operates the injection molding machine 100 under the new operating condition.

In another embodiment, the data processing apparatus 50a may include the manufacturing control unit 517 without including the display control unit 516. That is, the control method of the injection molding machine 100 may include the manufacturing control step without including the display control step. In still another embodiment, the data processing apparatus 50a may include the display control unit 516 without including the manufacturing control unit 517. That is, the control method of the injection molding machine 100 may include the display control step without including the manufacturing control step.

According to the second embodiment, when it is detected that the objective variable OV deviates from the threshold range, the data processing apparatus 50a can calculate a new operating condition for bringing the objective variable OV close to the reference value using the model function MF generated in advance. Then, the data processing apparatus 50a can operate the injection molding machine 100 under the new operating condition by displaying the new operating condition on the display device 507 and prompting the user of the injection molding machine 100 to change the operating condition. When the new operating condition is within the allowable range, the data processing apparatus 50a can automatically operate the injection molding machine 100 under the new operating condition without receiving input from the user. Accordingly, the data processing apparatus 50a can correct the deviation of the objective variable OV from the reference value. Therefore, the user can manufacture a desired product.

According to the second embodiment, the data processing apparatus 50a can predict the objective variable OV by substituting an optional conditional variable CV into the model function MF. Then, the data processing apparatus 50a can calculate a new operating condition of the injection molding machine 100 by searching for an operating condition that can bring the predicted value of the objective variable OV close to the predetermined value determined according to the difference from the reference value. That is, the data processing apparatus 50a can calculate a new operating condition of the injection molding machine 100 by calculation in the data processing apparatus 50a without acquiring new acquired data and searching for a new operating condition by trial and error as in Bayesian optimization. Accordingly, the data processing apparatus 50a can avoid an increase in the defect rate of the product due to the calculation of the new operating condition. Therefore, the data processing apparatus 50a can avoid an unstable state in which the defect rate of the product increases in the period for the calculation of the new operating condition and a loss of the molding material M1 occurs or the manufacturing efficiency decreases.

Even when the reference value itself of the objective variable OV is changed, such as when the weight of the product is changed due to a specification change of the product, the data processing apparatus 50a can calculate a new operating condition of the injection molding machine 100 using the model function MF.

According to the second embodiment, the model function MF can include an explanatory function of a predetermined order or less. According to the configuration, the data processing apparatus 50a can reduce the processing load when calculating a new operating condition of the injection molding machine 100. Accordingly, the data processing apparatus 50a can shorten the time required for calculating the new operating condition of the injection molding machine 100.

According to the second embodiment, the objective variable OV is, for example, quality information. According to the configuration, the data processing apparatus 50a can predict the quality of the product according to the operating condition of the injection molding machine 100 using the model function MF. When it is detected that the quality of the product deviates from the threshold range, the data processing apparatus 50a can calculate an operating condition for bringing the quality of the product close to the reference value and operate the injection molding machine 100. Accordingly, the user can manufacture a product having desired quality.

According to the second embodiment, the objective variable OV may be a cycle time when the product is manufactured. According to the configuration, the data processing apparatus 50a can predict the cycle time according to the operating condition of the injection molding machine 100 using the model function MF. When it is detected that the cycle time deviates from the threshold range, the data processing apparatus 50a can calculate an operating condition for bringing the cycle time close to the reference value and operate the injection molding machine 100. Accordingly, the user can manufacture the product at a desired cycle time.

According to the second embodiment, the objective variable OV may be a variation in the quality of the product. According to the configuration, the data processing apparatus 50a can predict the variation in the quality of the product occurring according to the operating condition of the injection molding machine 100 using the model function MF. Then, the data processing apparatus 50a can calculate the operating condition for suppressing the variation in the quality of the product and operate the injection molding machine 100. Accordingly, the user can manufacture two or more products with less variation in quality.

### C. Third Embodiment

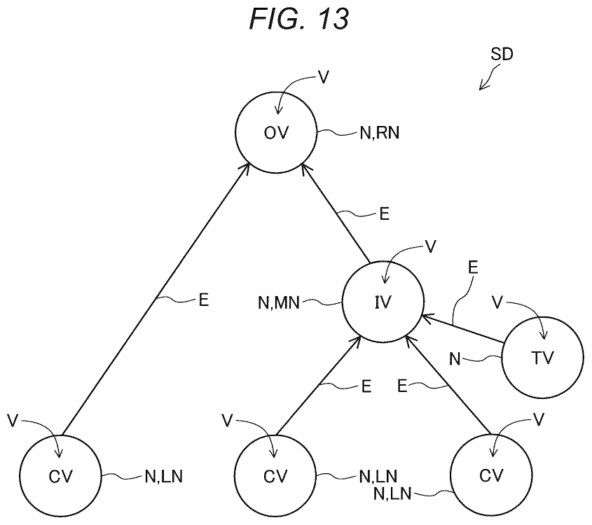

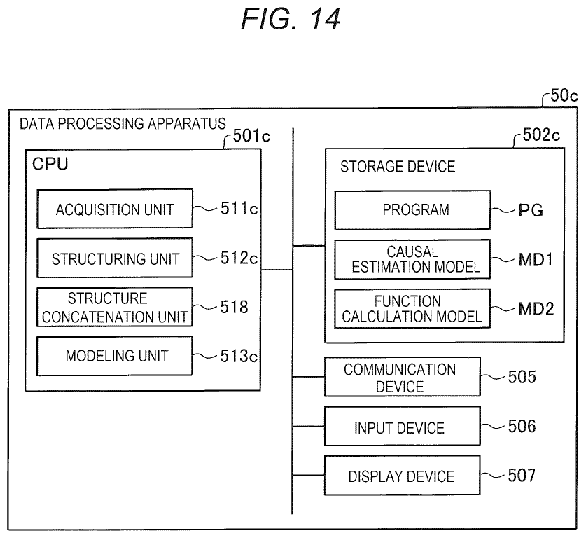

FIG. 12 is a block diagram showing a configuration of a data processing apparatus 50b according to a third embodiment. FIG. 13 is a conceptual diagram of structured data SD generated in the third embodiment. In the present embodiment, the data processing apparatus 50b generates a model function MF with addition of an element representing a change over time. Further, when it is detected that the objective variable OV deviates from the threshold range, the data processing apparatus 50b calculates a new operating condition of the injection molding machine 100 using the model function MF with addition of the element representing the change over time. The other configurations are the same as those of the second embodiment unless specifically explained otherwise. The same configurations as those of the second embodiment will have the same signs, and the description thereof will be omitted.

The data processing apparatus 50b includes a computer having a CPU 501b, a storage device 502b, the communication device 505, the input device 506, and the display device 507. The CPU 501b functions as an acquisition unit 511b, a structuring unit 512b, a modeling unit 513b, a condition calculation unit 514b, the display control unit 516 and the manufacturing control unit 517 as the functional unit 515 by executing a program PG stored in the storage device 502b.

The acquisition unit 511b acquires a data set including a temporal variable TV. The temporal variable TV is an explanatory variable representing a change over time when two or more products are manufactured. The temporal variable TV is, for example, an actual measurement value of a parameter that changes over time. The parameter that changes over time is, for example, the number of manufactured products.

The structuring unit 512b uses the data set including the temporal variable TV to generate structured data SD including a node N representing the temporal variable TV at a lower level than a root node RN.

The modeling unit 513b generates the model function MF using the data set including the temporal variable TV and the structured data SD including the node N representing the temporal variable TV.

When it is detected that the objective variable OV deviates from the threshold range, the condition calculation unit 514b calculates a new operating condition of the injection molding machine 100 using the model function MF with addition of the element representing the change over time. In the present embodiment, the condition calculation model MD3 can use the model function MF with addition of the element representing the change over time. Accordingly, by inputting the reference value itself to the condition calculation model MD3 as the predetermined value related to the reference value of the objective variable OV, a setting value of the new operating condition can be output from the condition calculation model MD3. Therefore, for example, in a case where the objective variable OV is the weight of the product and the reference value of the weight of the product is 10 g, when the weight of the product changes over time, the condition calculation unit 514b inputs 10 g, which is a reference value, to the condition calculation model MD3. Thus, the condition calculation unit 514b calculates a new operating condition of the injection molding machine 100.

According to the third embodiment, the data processing apparatus 50b can further acquire the temporal variable TV. Then, the data processing apparatus 50b can generate the structured data SD including the node N representing the temporal variable TV at the lower level than the root node RN. Then, the data processing apparatus 50b can generate the model function MF with addition of the element representing the change over time by using the data set including the temporal variable TV and the structured data SD including the node N representing the temporal variable TV. Accordingly, when it is detected that the objective variable OV deviates from the threshold range, the data processing apparatus 50b can calculate a new operating condition of the injection molding machine 100 by searching for an operating condition under which the predicted value of the objective variable OV can be brought close to the reference value itself. That is, the data processing apparatus 50b can calculate a new operating condition of the injection molding machine 100 without calculating the predetermined value related to the reference value of the objective variable OV using the difference from the reference value. Therefore, the data processing apparatus 50b can reduce the processing load when calculating the new operating condition of the injection molding machine 100. Accordingly, the data processing apparatus 50b can shorten the time required for calculating the new operating condition of the injection molding machine 100.

According to the third embodiment, the data processing apparatus 50b can generate the model function MF with addition of the element representing the change over time. As a result, the data processing apparatus 50b can detect an abnormality during manufacturing or predict a change over time in the objective variable OV using the model function MF.

### D. Fourth Embodiment

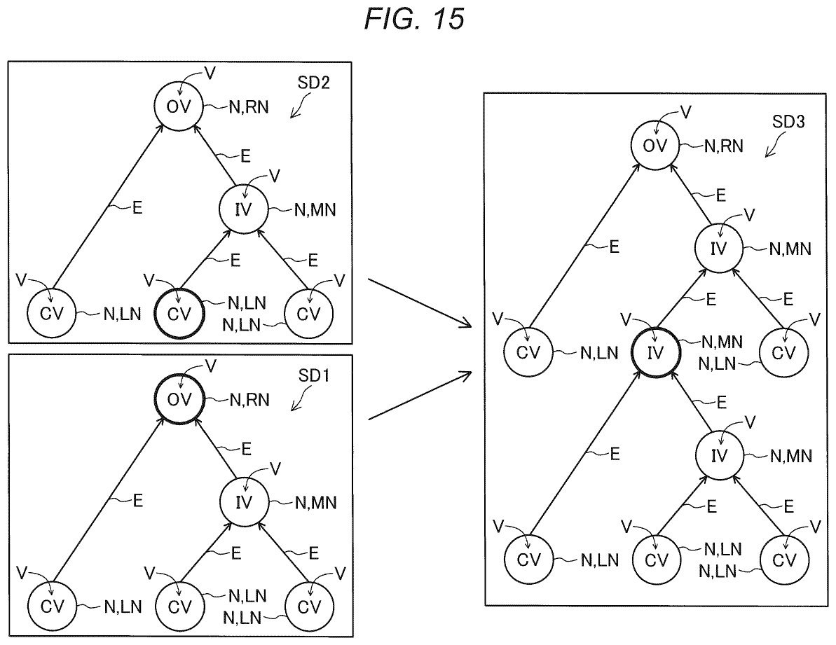

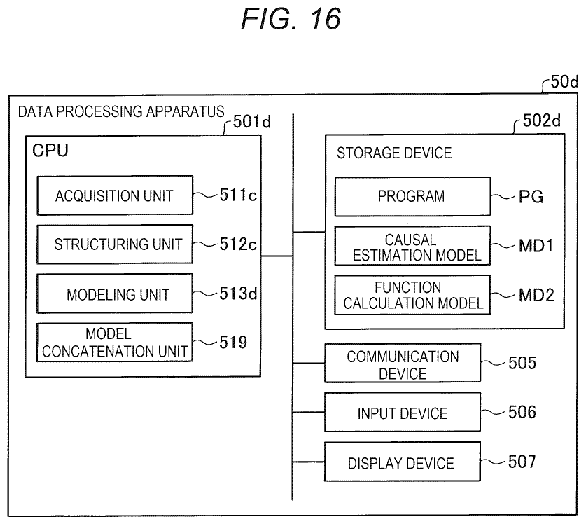

FIG. 14 is a block diagram showing a configuration of a data processing apparatus 50c according to a fourth embodiment. FIG. 15 is a conceptual diagram of structured data SD1 to SD3 generated in the fourth embodiment. In the present embodiment, the data processing apparatus 50c generates a model function MF after concatenating the two pieces of structured data SD. The other configurations are the same as those of the first embodiment unless specifically explained otherwise. The same configurations as those of the first embodiment will have the same signs, and the description thereof will be omitted.

The data processing apparatus 50c includes a computer having a CPU 501c, a storage device 502c, the communication device 505, the input device 506, and the display device 507. The CPU 501c functions as an acquisition unit 511c, a structuring unit 512c, a structure concatenation unit 518, and a modeling unit 513c by executing a program PG stored in the storage device 502c.

The acquisition unit 511c acquires a first data set and a second data set including an objective variable OV in the first data set as an explanatory variable. For example, the first data set includes two or more pieces of acquired data in the first step among the plurality of steps shown in FIG. 2. The second data set includes two or more pieces of acquired data in a second step executed after the first step among the plurality of steps shown in FIG. 2.

As illustrated in FIGS. 14 and 15, the structuring unit 512c generates the first structured data SD1 using the first data set and generates the second structured data SD2 using the second data set. For example, when the first data set includes the acquired data in the first step, the generated first structured data SD1 represents a causal structure between a conditional variable CV and the objective variable OV in the first step. When the second data set includes the acquired data in the second step, the generated second structured data SD2 represents a causal structure between the conditional variable CV and the objective variable OV in the second step.

The structure concatenation unit 518 generates composite structured data SD3 by concatenating the first structured data SD1 and the second structured data SD2. For example, when a root node RN of the first structured data SD1 and a leaf node LN of the second structured data SD2 represent the same element, the structure concatenation unit 518 concatenates the root node RN of the first structured data SD1 and the leaf node LN of the second structured data SD2 representing the same element to form an intermediate node MN, thereby coupling the first structured data SD1 and the second structured data SD2. As a result, the structure concatenation unit 518 generates the composite structured data SD3. For example, when the first structured data SD1 represents a causal structure in the first step and the second structured data SD2 represents a causal structure in the second step, the generated composite structured data SD3 represents a causal structure in two steps from the first step to the second step.

The modeling unit 513c generates the model function MF using the first data set, the second data set, and the composite structured data SD3. For example, when the composite structured data SD3 represents a causal structure in two steps from the first step to the second step, the generated model function MF is a function obtained by modeling the state of the injection molding machine 100 in the two steps from the first step to the second step.

According to the fourth embodiment, the data processing apparatus 50c can generate the composite structured data SD3 in which two pieces of structured data SD are combined into one by concatenating the two pieces of structured data SD. According to the configuration, the data processing apparatus 50c can easily generate the model function MF even when the causal structure between the conditional variable CV and the objective variable OV is complicated. Accordingly, even when the causal structure between the conditional variable CV and the objective variable OV is complicated, the data processing apparatus 50c can model the injection molding machine 100 by expressing the state of the injection molding machine 100 by one model function MF.

### E. Fifth Embodiment

FIG. 16 is a block diagram showing a configuration of a data processing apparatus 50d according to a fifth embodiment. In the present embodiment, the data processing apparatus 50d generates a composite model function by concatenating two model functions MF. The other configurations are the same as those of the fourth embodiment unless specifically explained otherwise. The same components as those of the fourth embodiment will have the same signs, and the description thereof will be omitted.

The data processing apparatus 50d includes a computer having a CPU 501d, a storage device 502d, the communication device 505, the input device 506, and the display device 507. The CPU 501d functions as the acquisition unit 511c, the structuring unit 512c, a modeling unit 513d, and a model concatenation unit 519 by executing a program PG stored in the storage device 502d.

The modeling unit 513d generates a first model function using the first structured data SD1 and generates a second model function using the second structured data SD2. For example, when the first structured data SD1 represents a causal structure in the first step, the generated first model function is a function obtained by modeling the state of the injection molding machine 100 in the first step. When the second structured data SD2 represents a causal structure in the second step, the generated second model function is a function obtained by modeling the state of the injection molding machine 100 in the second step.

The model concatenation unit 519 generates a composite model function by concatenating the first model function and the second model function. For example, when the first model function is a function obtained by modeling the state of the injection molding machine 100 in the first step and the second model function is a function obtained by modeling the state of the injection molding machine 100 in the second step, the generated composite model function is as described below. In this case, the generated composite model function is a function obtained by modeling the state of the injection molding machine 100 in two steps from the first step to the second step.

According to the fifth embodiment, the data processing apparatus 50d can generate a composite model function in which two model functions MF are combined into one by concatenating the two model functions MF. According to the configuration, the data processing apparatus 50d can easily generate the composite model function even when the causal structure between the conditional variable CV and the objective variable OV is complicated. Accordingly, even when the causal structure between the conditional variable CV and the objective variable OV is complicated, the data processing apparatus 50d can easily model the injection molding machine 100 by expressing the state of the injection molding machine 100 by one composite model function.

### F. Other Embodiments

### F-1. Other Embodiment 1

When a relationship between specific lower node UN and upper node AN is known and a physical quantity representing the relationship between the specific lower node UN and upper node AN can be calculated using a known function, the modeling units 513, 513b to 513d may perform the following operation. In this case, the modeling units 513, 513b to 513d may generate a model function MF including the physical quantity representing the relationship between the specific lower node UN and upper node AN instead of an explanatory function in which the relationship between the specific lower node UN and upper node AN is known. That is, the modeling units 513, 513b to 513d include a physical quantity fixedly representing an edge E connecting the specific lower node UN and upper node AN in the model function MF. The known function is a function that can express a relationship between the specific lower node UN and upper node AN without using the conditional variable CV. The known function is, for example, a physically trivial function. The known function may be a chemically trivial function. Or, the known function may be a trivial function from the support of a simulation or the like. For example, when the upper variables Z1 to 23 can be described by displacement x in linear motion with a constant acceleration, the modeling unit 513 generates the model function MF including the displacement x as a physical quantity calculated by substituting actual measurement values of an initial velocity v0, a time t, and an acceleration a into the following Expression (12).

$$x = v 0 \cdot t + a \cdot 1 / 2 \cdot {t}^{2} \qquad Expression ( 12 )$$

According to the configuration, the data processing apparatuses 50, 50b to 50d can generate the model function MF including the physical quantity calculated using the known function without calculating the explanatory function in which the relationship between the specific lower node UN and upper node AN is known.

### F-2. Other Embodiment 2

When the relationship between the specific lower node UN and upper node AN is known and the physical quantity representing the relationship between the specific lower node UN and upper node AN cannot be calculated using the known function, the modeling units 513, 513b to 513d may perform the following operation. In this case, the modeling units 513, 513b to 513d may generate the model function MF including a known function instead of the explanatory function in which the relationship between the specific lower node UN and upper node AN is known. Here, the modeling units 513, 513b to 513d may generate a model function MF including a known function KF having an order larger than a predetermined order, such as a first order or a second order. For example, when the upper variables Z1 to Z3 can be described by adding a term including a time t and a term including a value a·t² of multiplication of an acceleration a by square t² of the time t, the modeling units 513, 513b to 513d generate the model function MF including the known function KF shown in the following Expression (13).

$$KF = kT \cdot t + a \cdot kAT \cdot {t}^{2} \qquad Expression ( 13 )$$

In Expression (13), a first unknown coefficient kT is a coefficient representing an influence of the time t on the upper variables Z1 to Z3. A second unknown coefficient kAT is a coefficient representing an influence of a·t² of multiplication of the acceleration a by the square t² of the time t on the upper variables Z1 to Z3.

According to the configuration, the data processing apparatuses 50, 50b to 50d can generate the model function MF including the known function KF without calculating the explanatory function in which the relationship between the specific lower node UN and upper node AN is known.

### F-3. Other Embodiment 3

The modeling units 513, 513b to 513d may generate an explanatory function including various functions such as a logarithmic function, an exponential function, and a trigonometric function, or a model function MF including the known function KF. According to the configuration, when it is empirically known that the variable V of the specific node N exhibits a nonlinear behavior, the data processing apparatuses 50, 50a to 50d can more accurately represent the relationship between the operating condition of the injection molding machine 100 and the objective variable OV.

### F-4. Other Embodiment 4

The manufacturing apparatus 10 may be a molding machine other than the injection molding machine 100, such as a blow molding machine or a compression molding machine, or may be an apparatus other than the molding machine. When the manufacturing apparatus 10 is an apparatus other than the injection molding machine 100, the expression “injection molding machine” in the present disclosure can be appropriately replaced with “manufacturing apparatus”.

### F-5. Other Embodiment 5

At least part of the functions of the data processing apparatuses 50, 50a to 50d may be implemented as one function of the manufacturing apparatus 10. At least part of the functions of the manufacturing apparatus 10 may be implemented as one function of the data processing apparatuses 50, 50a to 50d. The manufacturing apparatus 10 and the data processing apparatuses 50, 50a to 50d may be configured integrally or separately.

### G. Other Configurations

The present disclosure is not limited to the above-described embodiments, but may be implemented by various configurations without departing from the spirit and scope of the present disclosure. For example, technical features in the embodiments corresponding to technical features in the aspects described in the summary section can be replaced and combined as appropriate in order to solve a part or all of the above-described problems or in order to achieve a part or all of the above-described effects. Further, the technical features can be deleted as appropriate unless described as essential features in the present specification.

(1) According to a first aspect of the present disclosure, a data processing apparatus is provided. The data processing apparatus includes an acquisition unit that acquires a data set including two or more pieces of acquired data acquired by operating a manufacturing apparatus under a predetermined operating condition to manufacture a product in which an objective variable related to the product and a conditional variable as an explanatory variable of the objective variable representing the operating condition are associated with each other, a structuring unit that generates structured data representing a causal structure between the conditional variable and the objective variable by connecting a leaf node representing the conditional variable, a root node representing the objective variable, and an intermediate node disposed between the leaf node and the root node and representing an influential variable as the explanatory variable representing an element having an influence on the objective variable and different from the operating condition by directed edges using the data set, and a modeling unit that models the manufacturing apparatus by sequentially calculating an explanatory function as a function representing a variable of an upper node as an end point of the specific edge by using a variable of a lower node as a start point of the specific edge from the leaf node to the root node using the data set, and generating a model function as a function including the calculated explanatory function. According to this aspect, the data processing apparatus can acquire the data set including two or more pieces of acquired data in which the conditional variable representing the operating condition of the manufacturing apparatus and the objective variable related to the product are associated with each other. Then, the data processing apparatus can generate the structured data representing the causal structure between the conditional variable and the objective variable using the data set. Then, the data processing apparatus sequentially calculates the explanatory function representing the variable of the upper node using the variable of the lower node from the leaf node to the root node using the data set and the structured data. Then, the data processing apparatus generates the model function as the function including the calculated explanatory function. Accordingly, the data processing apparatus can specify the relationship between the operating condition of the manufacturing apparatus and the objective variable by representing the relationship between the conditional variable and the objective variable by the model function. Here, the data processing apparatus calculates the explanatory function in order from the leaf node toward the upper level of the hierarchy. Therefore, the data processing apparatus can represent the influential variable representing the element having the influence on the objective variable using the conditional variable. That is, the data processing apparatus can quantitatively represent various elements having influences on the objective variable by the conditional variable. Thus, the data processing apparatus can specify the relationship between the operating condition of the manufacturing apparatus and the objective variable without acquiring a large volume of data and preparing a matrix for each of various elements having influences on the objective variable.

(2) In the aspect described above, two or more of the products may be manufactured, the acquisition unit may further acquire a temporal variable as the explanatory variable representing a change over time when the two or more products are manufactured, and the structuring unit may generate the structured data including a node representing the temporal variable at a lower level than the root node. According to the configuration, the data processing apparatus can further acquire the temporal variable representing the change over time. Then, the data processing apparatus can generate structured data including the node representing the temporal variable at the lower level than the root node. In this way, the data processing apparatus can generate the model function with addition of the element representing the change over time using the data set including the temporal variable and the structured data including the node representing the temporal variable. Accordingly, the data processing apparatus can predict the change over time of the objective variable using the model function.

(3) In the aspect described above, the modeling unit may calculate the explanatory function of a predetermined order or less. According to the configuration, the data processing apparatus can calculate the explanatory function of the predetermined order or less. Accordingly, the data processing apparatus can represent the relationship between the operating condition of the manufacturing apparatus and the objective variable with a simpler model function.

(4) In the aspect described above, in a case where a relationship between the specific lower node and the specific upper node is known, when a physical quantity representing the relationship is calculable using a known function as a function representing the relationship without using the conditional variable, the modeling unit may generate the model function including the physical quantity representing the relationship instead of the explanatory function in which the relationship is known without calculating the explanatory function in which the relationship is known. According to the configuration, the data processing apparatus can generate the model function including the physical quantity calculated using the known function without calculating the explanatory function in which the relationship between the specific lower node and the upper node is known.

(5) In the aspect described above, in a case where a relationship between the specific lower node and the specific upper node is known, when a physical quantity representing the relationship is not calculable using a known function as a function representing the relationship without using the conditional variable, the modeling unit may generate the model function including the known function instead of the explanatory function in which the relationship is known without calculating the explanatory function in which the relationship is known. According to the configuration, the data processing apparatus can generate the model function including the known function without calculating the explanatory function in which the relationship between the specific lower node and the upper node is known.

(6) In the aspect described above, when there are two or more of the lower nodes with respect to the upper node in the structured data, the modeling unit may generate the model function including the explanatory function representing an influence of each of the two or more lower nodes on the upper node and the explanatory function representing an influence of an interaction between a predetermined number of the lower nodes among the two or more lower nodes on the upper node. According to the configuration, the data processing apparatus can generate the model function including the explanatory function representing the influence of each of the two or more lower nodes on the upper node and the explanatory function representing the influence of the interaction between the two or more lower nodes on the upper node. Accordingly, the data processing apparatus can represent both the influence of one lower node on the upper node and the influence of the interaction between two or more lower nodes on the upper node by the model function. Further, according to the configuration, the data processing apparatus can generate the model function including the explanatory function representing the influence of the interaction between the predetermined number of lower nodes on the upper node. As a result, the data processing apparatus can suppress an increase in the processing load in the process of generating the model function or complication of the model function.

(7) In the aspect described above, the acquisition unit may acquire a first data set and a second data set including the objective variable in the first data set as the explanatory variable, and the structuring unit may generate first structured data using the first data set and may generate second structured data using the second data set, and the data processing apparatus may further include a structure concatenation unit that generates composite structured data by concatenating the first structured data and the second structured data. According to the configuration, the data processing apparatus can generate the composite structured data in which the two pieces of structured data are combined into one by concatenating the two pieces of structured data. Thus, the data processing apparatus can easily generate the model function even when the causal structure between the conditional variable and the objective variable is complicated.

(8) In the aspect described above, the acquisition unit may acquire a first data set and a second data set including the objective variable in the first data set as the explanatory variable, the structuring unit may generate first structured data using the first data set and generates second structured data using the second data set, and the modeling unit may generate a first model function using the first structured data and may generate a second model function using the second structured data, and the data processing apparatus may further include a model concatenation unit that generates a composite model function by concatenating the first model function and the second model function. According to the configuration, the data processing apparatus can generate the composite model function in which two model functions are combined into one by concatenating the two model functions. Thus, even when the causal structure between the conditional variable and the objective variable is complicated, the data processing apparatus can easily model the manufacturing apparatus by representing the state of the manufacturing apparatus by one composite model function.

(9) In the aspect described above, the data processing apparatus may further include a condition calculation unit that, when it is detected that the objective variable deviates from a threshold range including a predetermined reference value, calculates a new operating condition for bringing the objective variable close to the reference value using the model function, and a functional unit that functions when the new operating condition is calculated as at least one of a display control unit that prompts a user of the manufacturing apparatus to change the operating condition by displaying the new operating condition on a display device, and a manufacturing control unit that operates the manufacturing apparatus under the new operating condition when the new operating condition is within a preset allowable range. According to the configuration, when it is detected that the objective variable deviates from the threshold range, the data processing apparatus can calculate the new operating condition for bringing the objective variable close to the reference value using the model function generated in advance. Then, the data processing apparatus can operate the manufacturing apparatus under the new operating condition by displaying the new operating condition on the display device to prompt the user of the manufacturing apparatus to change the operating condition. When the new operating condition is within the allowable range, the data processing apparatus can automatically operate the manufacturing apparatus under the new operating condition without receiving input from the user. Accordingly, the data processing apparatus can correct the deviation of the objective variable from the reference value. Therefore, the data processing apparatus can manufacture a desired product using the manufacturing apparatus.

(10) According to a second aspect of the present disclosure, a data processing method is provided. The data processing method includes an acquisition step of acquiring a data set including two or more pieces of acquired data acquired by operating a manufacturing apparatus under a predetermined operating condition to manufacture a product in which an objective variable related to the product and a conditional variable as an explanatory variable of the objective variable representing the operating condition are associated with each other, a structuring step of generating structured data representing a causal structure between the conditional variable and the objective variable by connecting a leaf node representing the conditional variable, a root node representing the objective variable, and an intermediate node disposed between the leaf node and the root node and representing an influential variable as the explanatory variable representing an element having an influence on the objective variable and different from the operating condition by directed edges using the data set, and a modeling step of modeling the manufacturing apparatus by sequentially calculating an explanatory function as a function representing a variable of an upper node as an end point of the specific edge by using a variable of a lower node as a start point of the specific edge from the leaf node to the root node using the data set, and generating a model function as a function including the calculated explanatory function. According to this aspect, the data set including two or more pieces of acquired data in which the conditional variable representing the operating condition of the manufacturing apparatus and the objective variable related to the product are associated with each other can be acquired. Then, structured data representing the causal structure between the conditional variable and the objective variable can be generated using the data set. Then, the explanatory function representing the variable of the upper node using the variable of the lower node is sequentially calculated from the leaf node to the root node using the data set and the structured data. Then, a model function as the function including the calculated explanatory function is generated. Accordingly, the relationship between the operating condition of the manufacturing apparatus and the objective variable can be specified by representing the relationship between the conditional variable and the objective variable by the model function. Here, the explanatory function is calculated in order from the leaf node toward the upper level of the hierarchy. Therefore, the influential variable representing the element having an influence on the objective variable can be represented using the conditional variable. That is, various elements having influences on the objective variable can be quantitatively represented by the conditional variable. Therefore, the relationship between the operating condition of the manufacturing apparatus and the objective variable can be specified without acquiring a large volume of data and preparing a matrix for each of various elements affecting the objective variable.

(11) In the aspect described above, the method may further include a condition calculation step of, when it is detected that the objective variable deviates from a threshold range including a predetermined reference value, calculating a new operating condition for bringing the objective variable close to the reference value using the model function, and a functional step executed when the new operating condition is calculated as at least one of a display control step of prompting a user of the manufacturing apparatus to change the operating condition by displaying the new operating condition on a display device, and a manufacturing control step of operating the manufacturing apparatus under the new operating condition when the new operating condition is within a preset allowable range. According to the configuration, when it is detected that the objective variable deviates from the threshold range, a new operating condition for bringing the objective variable close to the reference value can be calculated using the model function generated in advance. Then, by displaying the new operating condition on the display device and prompting the user of the manufacturing apparatus to change the operating condition, the manufacturing apparatus can be operated under the new operating condition. When the new operating condition is within the allowable range, the manufacturing apparatus can be automatically operated under the new operating condition without receiving input from the user. Thus, the deviation of the objective variable from the reference value can be corrected. Therefore, a desired product can be manufactured using the manufacturing apparatus.

(12) According to a third aspect of the present disclosure, a non-transitory computer-readable storage medium storing a data processing program is provided. The data processing program is for causing a computer to execute an acquisition function of acquiring a data set including two or more pieces of acquired data acquired by operating a manufacturing apparatus under a predetermined operating condition to manufacture a product in which an objective variable related to the product and a conditional variable as an explanatory variable of the objective variable representing the operating condition are associated with each other, a structuring function of generating structured data representing a causal structure between the conditional variable and the objective variable by connecting a leaf node representing the conditional variable, a root node representing the objective variable, and an intermediate node disposed between the leaf node and the root node and representing an influential variable as the explanatory variable representing an element having an influence on the objective variable and different from the operating condition by directed edges using the data set, and a modeling function of modeling the manufacturing apparatus by sequentially calculating an explanatory function as a function representing a variable of an upper node as an end point of the specific edge by using a variable of a lower node as a start point of the specific edge from the leaf node to the root node using the data set, and generating a model function as a function including the calculated explanatory function. According to this aspect, the data set including two or more pieces of acquired data in which the conditional variable representing the operating condition of the manufacturing apparatus and the objective variable related to the product are associated with each other can be acquired. Then, structured data representing the causal structure between the conditional variable and the objective variable can be generated using the data set. Then, the explanatory function representing the variable of the upper node using the variable of the lower node is sequentially calculated from the leaf node to the root node using the data set and the structured data. Then, a model function as the function including the calculated explanatory function is generated. Accordingly, the relationship between the operating condition of the manufacturing apparatus and the objective variable can be specified by representing the relationship between the conditional variable and the objective variable by the model function. Here, the explanatory function is calculated in order from the leaf node toward the upper level of the hierarchy. Therefore, the influential variable representing the element having an influence on the objective variable can be represented using the conditional variable. That is, various elements having influences on the objective variable can be quantitatively represented by the conditional variable. Therefore, the relationship between the operating condition of the manufacturing apparatus and the objective variable can be specified without acquiring a large volume of data and preparing a matrix for each of various elements affecting the objective variable.

Not all of the plurality of component elements provided in each of the above-described embodiments of the present disclosure are essential, and in order to solve a part or all of the above-described problems, or to achieve a part or all of the effects described in the specification, part of the plurality of component elements can be changed, deleted, and replaced with other new component elements, and part of the limitations can be deleted in an appropriate manner. In order to resolve a part or all of the above-described problems or achieve a part or all of the effects described in the specification, a part or all of the technical features provided in the above-described one embodiment of the present disclosure can be combined with a part or all of the technical features provided in the above-described other embodiments of the present disclosure to form an independent embodiment of the present disclosure.

The present disclosure can be implemented in various forms other than the data processing apparatus, the data processing method, and the non-transitory computer-readable storage medium storing a data processing program. For example, the present disclosure can be implemented in forms such as a manufacturing system including the data processing apparatus and the manufacturing apparatus, a manufacturing method for the data processing apparatus and the manufacturing system, and a control method for the data processing system and the manufacturing system, a computer program for implementing the control method, and a non-transitory storage medium in which the computer program is recorded.

What is claimed is:

1. A data processing apparatus comprising:
an acquisition unit that acquires a data set including two or more pieces of acquired data acquired by operating a manufacturing apparatus under a predetermined operating condition to manufacture a product in which an objective variable related to the product and a conditional variable as an explanatory variable of the objective variable representing the operating condition are associated with each other;
a structuring unit that generates structured data representing a causal structure between the conditional variable and the objective variable by connecting a leaf node representing the conditional variable, a root node representing the objective variable, and an intermediate node disposed between the leaf node and the root node and representing an influential variable as the explanatory variable representing an element having an influence on the objective variable and different from the operating condition by directed edges using the data set; and
a modeling unit that models the manufacturing apparatus by sequentially calculating an explanatory function as a function representing a variable of an upper node as an end point of the specific edge by using a variable of a lower node as a start point of the specific edge from the leaf node to the root node using the data set, and generating a model function as a function including the calculated explanatory function.

2. The data processing apparatus according to claim 1, wherein
two or more of the products are manufactured,
the acquisition unit further acquires a temporal variable as the explanatory variable representing a change over time when the two or more products are manufactured, and
the structuring unit generates the structured data including a node representing the temporal variable at a lower level than the root node.

3. The data processing apparatus according to claim 1, wherein
the modeling unit calculates the explanatory function of a predetermined order or less.

4. The data processing apparatus according to claim 1, wherein
in a case where a relationship between the specific lower node and the specific upper node is known, when a physical quantity representing the relationship is calculable using a known function as a function representing the relationship without using the conditional variable, the modeling unit generates the model function including the physical quantity representing the relationship instead of the explanatory function in which the relationship is known without calculating the explanatory function in which the relationship is known.

5. The data processing apparatus according to claim 1, wherein
in a case where a relationship between the specific lower node and the specific upper node is known, when a physical quantity representing the relationship is not calculable using a known function as a function representing the relationship without using the conditional variable, the modeling unit generates the model function including the known function instead of the explanatory function in which the relationship is known without calculating the explanatory function in which the relationship is known.

6. The data processing apparatus according to claim 1, wherein
when there are two or more of the lower nodes with respect to the upper node in the structured data, the modeling unit generates the model function including the explanatory function representing an influence of each of the two or more lower nodes on the upper node and the explanatory function representing an influence of an interaction between a predetermined number of the lower nodes among the two or more lower nodes on the upper node.

7. The data processing apparatus according to claim 1, wherein
the acquisition unit acquires a first data set and a second data set including the objective variable in the first data set as the explanatory variable, and
the structuring unit generates first structured data using the first data set and generates second structured data using the second data set,
the data processing apparatus further comprising a structure concatenation unit that generates composite structured data by concatenating the first structured data and the second structured data.

8. The data processing apparatus according to claim 1, wherein
the acquisition unit acquires a first data set and a second data set including the objective variable in the first data set as the explanatory variable,
the structuring unit generates first structured data using the first data set and generates second structured data using the second data set, and
the modeling unit generates a first model function using the first structured data and generates a second model function using the second structured data,
the data processing apparatus further comprising a model concatenation unit that generates a composite model function by concatenating the first model function and the second model function.

9. The data processing apparatus according to claim 1, further comprising:
a condition calculation unit that, when it is detected that the objective variable deviates from a threshold range including a predetermined reference value, calculates a new operating condition for bringing the objective variable close to the reference value using the model function; and
a functional unit that functions when the new operating condition is calculated as at least one of a display control unit that prompts a user of the manufacturing apparatus to change the operating condition by displaying the new operating condition on a display device, and a manufacturing control unit that operates the manufacturing apparatus under the new operating condition when the new operating condition is within a preset allowable range.

10. A data processing method comprising:
an acquisition step of acquiring a data set including two or more pieces of acquired data acquired by operating a manufacturing apparatus under a predetermined operating condition to manufacture a product in which an objective variable related to the product and a conditional variable as an explanatory variable of the objective variable representing the operating condition are associated with each other;
a structuring step of generating structured data representing a causal structure between the conditional variable and the objective variable by connecting a leaf node representing the conditional variable, a root node representing the objective variable, and an intermediate node disposed between the leaf node and the root node and representing an influential variable as the explanatory variable representing an element having an influence on the objective variable and different from the operating condition by directed edges using the data set; and
a modeling step of modeling the manufacturing apparatus by sequentially calculating an explanatory function as a function representing a variable of an upper node as an end point of the specific edge by using a variable of a lower node as a start point of the specific edge from the leaf node to the root node using the data set, and generating a model function as a function including the calculated explanatory function.

11. The data processing method according to claim 10, further comprising:
a condition calculation step of, when it is detected that the objective variable deviates from a threshold range including a predetermined reference value, calculating a new operating condition for bringing the objective variable close to the reference value using the model function; and
a functional step executed when the new operating condition is calculated as at least one of a display control step of prompting a user of the manufacturing apparatus to change the operating condition by displaying the new operating condition on a display device, and a manufacturing control step of operating the manufacturing apparatus under the new operating condition when the new operating condition is within a preset allowable range.

12. A non-transitory computer-readable storage medium storing a data processing program for causing a computer to execute:
an acquisition function of acquiring a data set including two or more pieces of acquired data acquired by operating a manufacturing apparatus under a predetermined operating condition to manufacture a product in which an objective variable related to the product and a conditional variable as an explanatory variable of the objective variable representing the operating condition are associated with each other;
a structuring function of generating structured data representing a causal structure between the conditional variable and the objective variable by connecting a leaf node representing the conditional variable, a root node representing the objective variable, and an intermediate node disposed between the leaf node and the root node and representing an influential variable as the explanatory variable representing an element having an influence on the objective variable and different from the operating condition by directed edges using the data set; and
a modeling function of modeling the manufacturing apparatus by sequentially calculating an explanatory function as a function representing a variable of an upper node as an end point of the specific edge by using a variable of a lower node as a start point of the specific edge from the leaf node to the root node using the data set, and generating a model function as a function including the calculated explanatory function.
